(19) United States
(12) Patent Application Publication
(10) Pub. No.: US 2025/0002661 A1
(43) Pub. Date: Jan. 2, 2025

(54) BIOPOLYMER PARTICLES AND THEIR PREPARATION

(71) Applicant: Naturbeads Ltd, Malmesbury Wiltshire (GB)

(72) Inventors: Amy R Wilson, Malmesbury Wiltshire (GB); Davide Mattia, Malmesbury Wiltshire (GB); Lolan Naicker, Malmesbury Wiltshire (GB)

(73) Assignee: Naturbeads Ltd, Malmesbury Wiltshire (GB)

(21) Appl. No.: 18/695,555

(22) PCT Filed: Sep. 23, 2022
(86) PCT No.: PCT/GB2022/052411

§ 371 Date: Mar. 26, 2024

(30) Foreign Application Priority Data
Sep. 28, 2021 (GB) 2113850.8

(51) Int. Cl. C08J 3/14; C08J 3/05

(52) U.S. Cl. CPC C08J 3/14; C08J 3/05; C08J 2301/02; C08J 2305/00

(57) ABSTRACT

The present disclosure provides methods for preparing biopolymer particles. One aspect provides a method comprising extruding a dispersed phase into an anti-solvent to form particles of the biopolymer, wherein the dispersed phase comprises the biopolymer in a solvent. Another aspect provides a method comprising: a membrane emulsification of a dispersed phase into a continuous phase wherein the dispersed phase comprises the biopolymer in a solvent, and wherein passing the dispersed phase through the membrane forms an emulsion of the biopolymer in the continuous phase: and a phase inversion with an anti-solvent to form particles of the biopolymer. In both aspects, each of the solvent and anti-solvent comprises water. Also provided are biopolymer particles obtained from the methods.

### FIELD

The present disclosure relates generally to methods for preparing biopolymer particles, and more particularly, to methods for preparing biopolymer particles suitable for applications in, but not limited to, cosmetics, personal care, paints & coatings, packaging, construction, oil & gas, food, biomedical and pharmaceuticals and/or having improved environmental characteristics. The present disclosure also provides biopolymer particles obtained by the inventive methods.

### BACKGROUND

Biopolymers are an important development in the reduction of consumer products' environmental footprint. Materials made from polymers are widely used because of their adaptability, durability and price, so much so that it is difficult to identify consumer products that do not contain any polymeric material. However, many synthetic polymers that have been developed are mainly derived from petroleum and gas as raw materials meaning that they are incompatible with the environment and reliant on an unsustainable resource. Polymer particles in particular pose serious ecological problems because they often remain in ecosystems following disposal of the product by the consumer. Biopolymers and biopolymer particles thus go a long way in addressing these problems since they are often biodegradable as well as being derived from renewable and sustainable raw materials. However, the production of biopolymer particles remains challenging, and some of the reagents typically used in their preparation are still associated with environmental and/or safety concerns.

One method which has been used to prepare biopolymer particles is membrane emulsification followed by phase inversion. In the membrane emulsification process, a dispersed phase of a biopolymer is forced through pores of a microporous membrane directly into a continuous phase so as to form an emulsion from which the particles can be extracted. The particles in the emulsion are then subjected to a phase inversion, which involves exposing the emulsion to an anti-solvent, e.g. by immersing the emulsion into the anti-solvent. However, solvents and anti-solvents used in such processes typically comprise compounds that would be unsuitable for the preparation of particles for specific applications, for example due to safety concerns. Dimethyl sulfoxide (DMSO), for example, may be used as a co-solvent with 1-ethyl-3-methylimidazolium acetate (EmimOAc) for the direct dissolution of cellulose, but DMSO is listed in Annex II of Regulation (EC) No. 1223/2009 on Cosmetic Products (available at https://echa.europa.eu/cosmetics-prohibited-substances). The use of such compounds may also pose environmental concerns and may, for example, make solvent recycling more difficult and costly, thus preventing the environmental benefits of biopolymer particles from being fully realised.

Overall there remains a need in the art for methods of preparing biopolymer particles that do not suffer from the above-mentioned problems. In particular, methods that avoid the use of solvents and/or anti-solvents that are undesirable, unsuitable, or prohibited for use in specific applications, and/or which have a negative impact on the overall environmental benefits of the biopolymer particles. The methods of the present disclosure satisfy this unmet need.

### SUMMARY

In one aspect, the present disclosure provides a method for preparing biopolymer particles, said method comprising extruding a dispersed phase into an anti-solvent to form particles of the biopolymer, wherein the dispersed phase comprises the biopolymer in a solvent, and wherein each of the solvent and anti-solvent comprises water.

In a second aspect, the present disclosure provides a method for preparing biopolymer particles, said method comprising: (a) a membrane emulsification of a dispersed phase into a continuous phase wherein the dispersed phase comprises the biopolymer in a solvent, and wherein passing the dispersed phase through the membrane forms an emulsion of the biopolymer in the continuous phase; and (b) a phase inversion with an anti-solvent to form particles of the biopolymer; wherein each of the solvent and anti-solvent comprises water.

It will be understood by the person skilled in the art that overlapping features between the method of the first aspect and the method of the second aspect may be discussed herein with reference to one method but such discussion will be equally applicable to the other method. Discussion of, for example, the solvent of the dispersed phase and the anti-solvent applies in each aspect, as well as the biopolymer.

In a third aspect, the present disclosure provides biopolymer particles obtained by each of the methods described herein. Features described herein in the context of the methods are also therefore applicable to the biopolymer particles obtained by the methods. Biopolymer particles obtained by the methods described herein are distinguishable over the prior art because the use of water in the solvent and anti-solvent during their preparation avoids the presence of undesirable and/or prohibited compounds (e.g. DMSO) in the particles, making such particles suitable for example in cosmetics, and also reduces the environmental impact of the process by which the particles are prepared. Additionally, the use of water in the solvent may improve the yield of the methods of the present disclosure and/or regularity of size and shape of the obtained particles.

In various embodiments of the first aspect, extruding the dispersed phase into an anti-solvent to form particles of the biopolymer comprises extruding the dispersed phase through a fluid medium by capillary extrusion. Extrusion through a fluid medium may involve extruding the dispersed phase into a mould and then contacting the extruded dispersed phase with the anti-solvent. The mould may be used in combination with capillary extrusion.

In various embodiments of the first aspect, the extruded dispersed phase is dropped from a height of about 1 cm to about 80 cm above the surface of the anti-solvent, preferably from a height of about 5 cm to about 70 cm above the surface of the anti-solvent, more preferably from a height of about 10 cm to about 60 cm above the surface of the anti-solvent.

In various embodiments of the second aspect, prior to (b), the emulsion is cooled to a temperature, T₁, T₁ being greater than the pour point of the continuous phase (T_{cont}), and equal to or less than a transition temperature of the dispersed phase (T_{disp}): T_{cont}<T₁≤T_{disp}; wherein the transition temperature is selected from the group consisting of the freezing point, the glass transition temperature, and the pour point; and wherein T_{disp}>T_{cont}. The anti-solvent may further be cooled to a temperature, T₂, for the phase inversion (b), T₂ being less than T_{disp}, preferably wherein T₂ is equal to T₁.

In various embodiments of any of the aspects of the present disclosure, the biopolymer is a polysaccharide, preferably the biopolymer is cellulose. When the biopolymer is cellulose, the cellulose may be selected from the group consisting of virgin, recycled, pulp, and microcrystalline cellulose, and combinations thereof, preferably the biopolymer may be microcrystalline cellulose.

In various embodiments of any of the aspects of the present disclosure, the biopolymer is present in the dispersed phase in an amount from about 2 wt % to about 12 wt %, preferably from about 4 wt % to about 10 wt %.

In various embodiments of any of the aspects of the present disclosure, the dispersed phase is prepared by the addition of the biopolymer to the solvent, and wherein the solvent comprises water prior to the addition of the biopolymer. Alternatively in various embodiments of any of the aspects of the present disclosure, the dispersed phase is prepared by the addition of the biopolymer to the solvent, and wherein the solvent comprises water only after the addition of the biopolymer.

In various embodiments of any of the aspects of the present disclosure, the solvent of the dispersed phase comprises from about 2 wt % to about 12 wt % of water, preferably from about 4 wt % to about 10 wt % of water. In various embodiments of any of the aspects of the present disclosure, the solvent of the dispersed phase further comprises an ionic liquid. The ionic liquid may comprise 1-ethyl-3-methylimidazolium acetate.

In various embodiments of any of the aspects of the present disclosure, the anti-solvent is substantially free of organic solvents. The term “substantially free” is defined further herein. In various embodiments of any of the aspects of the present disclosure, the anti-solvent further comprises an ionic liquid. The ionic liquid may comprise 1-ethyl-3-methylimidazolium acetate.

In various embodiments of any of the aspects of the present disclosure, the ionic liquid is present in the anti-solvent at a concentration of up to about 50 wt %, preferably up to about 30 wt %. For example, the ionic liquid may be present in the anti-solvent at a concentration of between about 0.001 wt % and about 50 wt %, preferably between about 0.001 wt % and about 30 wt %. Further concentrations are discussed herein. Alternatively, in various embodiments of any of the aspects of the present disclosure, the anti-solvent consists of water.

In various embodiments of any of the aspects of the present disclosure, the temperature of the dispersed phase is from about 5° C. to less than about 100° C., preferably from about 20° C. to about 80° C., more preferably from about 25° C. to about 70° C.

In various embodiments of any of the aspects of the present disclosure, the temperature of the anti-solvent is from about 5° C. to about 80° C., preferably from about 15° C. to about 60° C.

In various embodiments of any of the aspects of the present disclosure, the diameter of the biopolymer particles is from about 1 μm to about 500 μm. Alternatively the diameter of the biopolymer particles may be from about 0.2 mm to about 3 mm. In a further alternative, the diameter of the biopolymer particles may be from about 1 mm to about 10 mm.

These aspects and embodiments are set out in the appended independent and dependent claims. It will be appreciated that features of the dependent claims may be combined with each other and with features of the independent claims in combinations other than those explicitly set out in the claims. Furthermore, the approaches described herein are not restricted to specific embodiments such as those set out below, but include and contemplate any combinations of features presented herein.

The foregoing and other objects, features, and advantages of the present disclosure will appear more fully hereinafter from a consideration of the detailed description that follows along with the accompanying drawings. It is to be expressly understood, however, that the drawings are for illustrative purposes and are not to be construed as defining the limits of the disclosure.

### BRIEF DESCRIPTION OF THE DRAWINGS

FIG. 1 is a schematic representation of an embodiment of the first aspect wherein the dispersed phase of the present disclosure is extruded into an anti-solvent.

FIG. 2 is a schematic representation of membrane emulsification.

FIG. 3 contains four photographs of particles showing an example of a particle with a desirable shape (spherical) (FIG. 3(a)), alongside examples of the deformation and aggregation problems that may occur with earlier membrane emulsification methods (FIGS. 3(b) to 3(d)).

FIG. 4 contains a schematic representation of an earlier membrane emulsification process (FIG. 3(a)), and a representation of an embodiment of the emulsion cooling according to the second aspect of the present disclosure (FIG. 4(b)).

FIG. 5 shows optical micrographs of solutions of microcrystalline cellulose (MCC) in EmimOAc, optionally with 8 wt % water present. The labels (a) to (g) refer to the following MCC solutions: a) 4 wt % MCC; b) 6 wt % MCC; c) 8 wt % MCC; d) 4 wt % MCC, 8 wt % water; e) 6 wt % MCC, 8 wt % water; f) 8 wt % MCC, 8 wt % water; g) reference standard (8 wt % MCC in 70:30 DMSO:EmimOAc). The preparation of the cellulose solutions and the reference standard is described in the Examples herein.

FIG. 6 shows images of microcrystalline cellulose (MCC) beads/particles in their wet state after formation with 8 wt % water by an exemplary embodiment of the first aspect of the present disclosure, compared with formation without water. The photographs are further labelled with the wt % MCC (corresponding to the solutions shown in FIG. 5) and temperature of the dispersed phase; RT means room temperature. The preparation of the beads/particles in their wet state is described in Example 2 herein.

FIG. 7 shows optical micrographs of dried microcrystalline cellulose (MCC) beads/particles obtained with 8 wt % water by an exemplary embodiment of the first aspect of the present disclosure, compared with beads/particles obtained without 8 wt % water. The optical micrographs are further labelled with the wt % MCC (corresponding to the solutions shown in FIG. 5) and the temperature of the dispersed phase; RT means room temperature. The preparation of the dried beads/particles is described in Example 2 herein.

FIG. 8 shows images of wet microcrystalline cellulose beads/particles produced using a solution of 8 wt % MCC and 8 wt % water in EmimOAc and a heated syringe in an exemplary embodiment of the first aspect of the present disclosure. This embodiment is described in Example 3 herein. The MCC beads/particles are further characterized with their dropping height (13 cm; 26 cm; or 39 cm) and the temperature of the syringe needle during extrusion.

FIG. 9 shows optical micrographs of dried microcrystalline cellulose beads/particles produced using a solution of 8 wt % MCC and 8 wt % water in EmimOAc and a heated syringe in an exemplary embodiment of the first aspect of the present disclosure. This embodiment is described in Example 3 herein. As in FIG. 8, the MCC beads/particles are characterised with their dropping height and the temperature of the syringe needle during extrusion.

FIG. 10 shows images of wet microcrystalline cellulose beads/particles produced using a solution of 6 wt % MCC and 8 wt % water in EmimOAc and a heated syringe in an exemplary embodiment of the first aspect of the present disclosure. This embodiment is described in the Example 3 herein. The MCC beads/particles are further characterised with their dropping height and the temperature of the syringe needle during extrusion.

FIG. 11 shows optical micrographs of dried microcrystalline cellulose beads/particles produced using a solution of 6 wt % MCC and 8 wt % water in EmimOAc and a heated syringe in an exemplary embodiment of the first aspect of the present disclosure. This embodiment is described in Example 3 herein. The MCC beads/particles are further characterised with their dropping height and the temperature of the syringe needle during extrusion.

FIG. 12 is a graph of viscosity (Pa·s) against temperature (° C.) for the cellulose solutions prepared in the Examples (with and without 8 wt % water). The viscosity is measured as described herein at a shear rate of 1 s⁻¹. The horizontal dashed line at 1.89 Pa·s indicates the viscosity of the reference solution (8 wt % MCC in a 70:30 mixture of DMSO: EmimOAc at room/ambient temperature).

### DETAILED DESCRIPTION

While various exemplary embodiments are described or suggested herein, other exemplary embodiments utilizing a variety of methods and materials similar or equivalent to those described or suggested herein are encompassed by the general inventive concepts. Those aspects and features of embodiments which are implemented conventionally may not be discussed or described in detail in the interests of brevity. It will thus be appreciated that aspects and features of apparatus and methods described herein which are not described in detail may be implemented in accordance with any conventional techniques for implementing such aspects and features.

As used in this specification and the claims, the singular forms “a,” “an,” and “the” include plural referents unless the context clearly dictates otherwise.

In this specification, unless otherwise stated, the term “about” modifying the quantity of a component refers to variation in the numerical quantity that can occur, for example, through typical measuring and handling procedures used for making concentrates, mixtures or solutions in the real world; through inadvertent error in these procedures; through differences in the manufacture, source, or purity of the materials employed, or to carry out the methods; and the like. The term “about” also encompasses amounts that differ due to different equilibrium conditions for a composition resulting from a particular initial mixture. Whether or not modified by the term “about”, the claims include equivalents to the quantities.

The ranges provided herein provide exemplary amounts of each of the components. Each of these ranges may be taken alone or combined with one or more other component ranges.

As used herein, the term “at least” includes the end value of the range that is specified. For example, “at least 10 cm” includes the value 10 cm.

As used herein, wt % means “weight percentage” as the basis for calculating a percentage. Unless indicated otherwise, all % values are calculated on a weight basis, and are provided with reference to the total weight of the product in which the substance is present. For example, % water in the solvent of the dispersed phase refers to the wt % water based on the total weight of the solvent. Similarly, % biopolymer in the dispersed phase refers to wt % biopolymer based on the total weight of the dispersed phase.

As used herein, “substantially free” means no more than trace amounts, i.e. the amount of the substance(s) concerned is negligible. In various embodiments, “substantially free” means no more than 1000 ppm, preferably no more than 100 ppm, more preferably no more than 10 ppm, even more preferably no more than 1 ppm of the substance(s) concerned.

The general inventive concept is centred on providing a method for preparing biopolymer particles, where the biopolymer particles are suitable for use in applications in, but not limited to, cosmetics, personal care, paints & coatings, packaging, construction, oil & gas, food, biomedical and pharmaceuticals and have improved environmental benefits. As well as being suitable for the above applications, the particles must also be prepared at a reasonable yield so as to ensure that the method is commercially viable. Yield in the present disclosure refers to the mass of spherical particles or beads within a defined size distribution. Spherical particles are notably desirable and yet processes for preparing biopolymer particles, particularly membrane emulsification processes, often suffer from coalescence or aggregation, as well as deformation, of the produced particles. Such mechanisms risk reducing the yield and hence the commercial viability of the process. Extrusion processes can also suffer from coalescence or aggregation issues, primarily due to the viscosity of the solution being extruded.

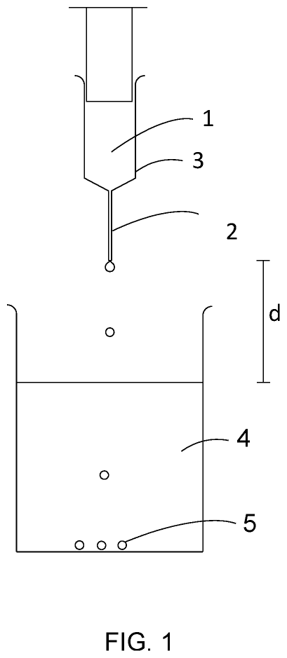

In a first aspect, the present disclosure provides a method for preparing biopolymer particles wherein said method comprises extruding a dispersed phase into an anti-solvent to form particles of the biopolymer. The dispersed phase comprises the biopolymer in a solvent as discussed further below, and the extrusion of such a dispersed phase is known in the art. It is a process wherein the dispersed phase is forced, pressed, or pushed out, for example through an aperture or opening. The opening may be in a syringe as shown in FIG. 1 or any other suitable extrusion device as known in the art.

A schematic representation of an exemplary embodiment of the extrusion process of the present disclosure is shown in FIG. 1. In the exemplary embodiment of FIG. 1, the dispersed phase (1) comprising the biopolymer in a solvent is extruded through a needle (2) of a syringe (3). Extrusion is specifically into the anti-solvent (4) to form biopolymer particles (5). In the exemplary embodiment of FIG. 1, the extruded dispersed phase is dropped from a height, d, above the surface of the anti-solvent.

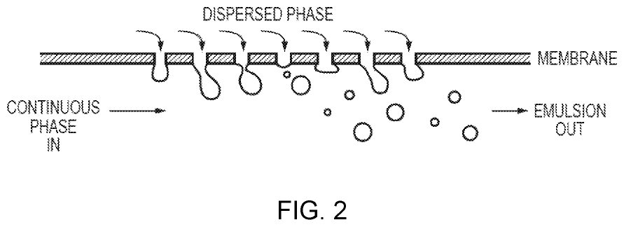

In a second aspect, the present disclosure provides a method for preparing biopolymer particles comprising a membrane emulsification step and a phase inversion step. Membrane emulsification is known in the art; it is a technique in which a dispersed phase is forced through the pores of a microporous membrane directly into a continuous phase, where emulsified droplets are formed and detached at the end of the pores with a drop-by-drop mechanism. A schematic representation of a membrane emulsification process is shown in FIG. 2, where the arrow indicates the direction of flow.

The dispersed phase generally includes a first liquid containing the biopolymer dissolved in a solvent, and the continuous phase includes a second liquid which is immiscible with the first liquid. The interaction of the two liquids when the dispersed phase is pushed or otherwise transported through the membrane is called a dispersion process, and their inhomogeneous mixture is termed an emulsion, i.e. droplets of the dispersed phase surrounded by the continuous phase.

The advantages of membrane emulsification over conventional emulsification are recognised in the art; they include the ability to obtain very fine emulsions of controlled droplet sizes and narrow droplet size distributions. In addition, successful emulsification can be carried out with much less consumption of energy, and because of the lowered shear stress effect, membrane emulsification allows the use of shear-sensitive ingredients, such as starch and proteins.

In the context of producing biopolymers, the droplets of dispersed phase in continuous phase have been successfully isolated by phase inversion. In the context of cellulose, this is described in ACS Sustainable Chem. Eng. 2017, 5, 7, 5931-5939, which is incorporated herein by reference. Phase inversion is a chemical phenomenon exploited in the fabrication of artificial membranes, and is performed by removing solvent from a liquid-polymer solution. There are various methods of phase inversion including immersing the polymer solution into a third liquid called the anti-solvent. The use of anti-solvent based phase inversion has proven to be particularly effective in precipitating droplets of biopolymer into particles from an emulsion of dispersed/continuous phase.

Common to both aspects of the present disclosure is the use of a solvent into which the biopolymer is dissolved to form the dispersed phase, and the use of an anti-solvent to form the biopolymer particles.

Solvents for use in the preparation of biopolymer particles, particularly by membrane emulsification or extrusion, are known and ionic liquids are commonly favoured as they are able to solubilise recalcitrant biopolymers. Ionic liquids are salts that are in liquid form at a temperature between ambient temperature and 100° C., for example imidazolium based ionic liquids such as 1-ethyl-3-methylimidazolium acetate (EmimOAc), 1-butyl-3-methylimidazolium chloride (BmimOAc) or the like. Moreover, ionic liquids are essentially non-volatile (avoiding fugitive emissions) and are considered to have environmental benefits over other solvents. Ionic liquids can, for example, be readily recycled by distillation to remove the anti-solvent.

Ionic liquids are typically not used in pure form, however. An amount of a co-solvent is often added to the ionic liquid when dissolving biopolymers such as cellulose. The use of a co-solvent may assist in dissolution of the biopolymer, and may reduce the amount of costly ionic liquid required. In methods for forming biopolymer particles, the inclusion of a co-solvent may also improve the efficiency and yield of the process by modifying the viscosity of the dispersed phase, which may in turn reduce the amount of deformation exhibited by the particles.

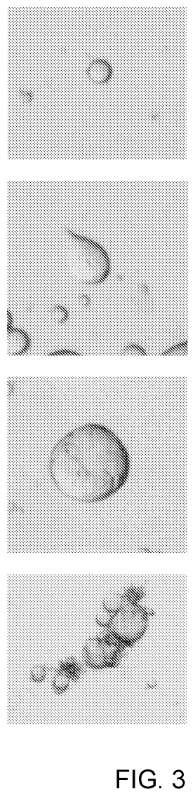

Four biopolymer particle shapes obtained by a membrane emulsification process are shown in FIGS. 3(a) to 3(d). FIG. 3(a) shows an exemplary particle shape and size which may be desirable in certain applications: an individual spherical bead with a diameter of <50 μm; FIG. 3(b) shows an undesirable shape deformation: an individual tear-drop shaped particle; FIG. 3(c) shows an undesirable coalescence of multiple spherical particles having a diameter of >200 μm; and FIG. 3(d) shows an undesirable asymmetric aggregation of multiple beads. Deformation, agglomeration and aggregation impact both the size and shape distribution of the biopolymer particles and this has a negative effect on the biopolymer particle yield.

The term “agglomerate” refers to a structure composed of primary particles which can typically be dispersed again. The term “aggregate” refers to a structure composed of primary particles which cannot be dispersed again. The term “tailing” refers to particles that are not fully spherical but exhibit one or more (typically one) protrusions, for example the tear-drop shaped particle shown in FIG. 3(b).

In situ inspection of the particles during formation is challenging and so it is only possible to theorise as to where and how any deformed shapes, coalesced structures, aggregated structures etc. are formed. Without wishing to be bound by any one theory, the inventors believe that dispersed phase droplets may undesirably interact with each other when flowing in the apparatus typically used for membrane emulsification or in the process piping, fittings, and equipment thereafter. These droplets may, for example, coalesce when there are changes in the fluid transport flow regime such as laminar to turbulent transition points, recirculation zones, flow direction changes etc. Another theory is that dispersed phase droplets may, for example, be deformed by shear forces during the phase inversion process (e.g. as the emulsion flows through the anti-solvent) and that these deformed shapes (e.g. tear drop) may be preserved by the anti-solvent. Dispersed phase droplets may also interact during the phase inversion process before or during contact with the anti-solvent, and may coalesce to create a larger droplet or group together to create a larger structure which is then preserved by the anti-solvent. Other mechanisms may also exist, including the consumption of smaller phase inverted particles by larger droplets during the phase inversion process and subsequent preservation of these structures by the anti-solvent. In an extrusion process such as those disclosed herein, the sphericity of particles obtained may depend on parameters such as the dropping height, temperature, and composition of the dispersed phase, as discussed in more detail below.

Typical co-solvents employed in combination with ionic liquids are dipolar aprotic solvents, such as dimethyl sulfoxide (DMSO), dimethylformamide (DMF), and the like. However, such solvents are not generally considered to be environmentally friendly, and the use thereof may therefore have a negative impact on the overall environmental benefits of ‘green’ processes that use ionic liquids. Notably, DMSO is listed in Annex II of Regulation (EC) No. 1223/2009 on Cosmetic Products (available at https://echa.europa.eu/cosmetics-prohibited-substances), and DMF is associated with toxic effects. Such co-solvents therefore cannot be used in processes for the preparation of biopolymer particles for use in cosmetic and personal care as well as other applications. The use of dipolar aprotic solvents may also complicate the recycling of the ionic liquid and increase costs. For example, some degree of distillation of DMSO is to be expected during recycling and the presence of aprotic solvent has been reported to reduce the thermal stability of 1-ethyl-3-methylimidazolium acetate (EmimOAc) [see Williams et al., Thermochimica Acta (2018), 669:126-139, for example].

Turning now to the anti-solvents used when preparing biopolymer particles, organic solvents such as ethanol are typical. Again, however, these substances may reduce the overall environmental benefits of the process, may be associated with safety concerns, and may complicate and increase the cost of recycling of ionic liquids.

The present disclosure surprisingly avoids the issues discussed above through the use of an aqueous solvent and an aqueous anti-solvent. Although water may generally be considered an anti-solvent for biopolymers such as cellulose, the inventors have found that including water in the solvent of the dispersed phase can efficiently dissolve/disperse biopolymers such as cellulose while providing dispersed phase compositions that allow their use in the methods disclosed herein to produce biopolymer particles in good yield.

The use of an aqueous solvent and anti-solvent obviates the use of reagents associated with environmental and safety concerns, and in particular, the use of reagents prohibited for use in cosmetic and personal care products and other applications. Aqueous solvents and anti-solvents may also simplify and reduce the cost of solvent recycling. In particular, use of such solvents and anti-solvents may increase the stability of ionic liquids against temperature-based degradation [Williams et al., Thermochimica Acta (2018), 669:126-139], which may allow an increased number of recycling cycles to be performed, for example. Finally, the inclusion of water in the dispersed phase may increase the likelihood of bead sphericity by minimising tailing, and thereby improve the yield of the methods disclosed herein.

For ease of reference, these and further features of the present invention are now discussed under appropriate section headings. However, the teachings under each section are not limited to the section in which they are found. Unless defined otherwise, all technical and scientific terms used herein have the same meaning as commonly understood by one of ordinary skill in the art to which the disclosure belongs.

### Biopolymer Particles

All aspects of the present disclosure concern biopolymer particles. By the term “biopolymer” is meant a polymer produced by living organisms. In other words, a polymeric biomolecule. There are three main classes of biopolymers, classified according to the monomeric units used and the structure of the biopolymer formed: polynucleotides (RNA and DNA), which are polymers composed of 13 or more nucleotide monomers; polypeptides, which are polymers of amino acids; and polysaccharides, which are typically polymeric carbohydrate structures. Other examples of biopolymers include rubber, suberin, melanin, chitin and lignin.

In various embodiments of the present invention, the biopolymer is selected from the group consisting of polynucleotides, polypeptides and polysaccharides. Preferably, the biopolymer is selected from the group consisting of polypeptides and polysaccharides. More preferably, the biopolymer is a polysaccharide, for example, starch, cellulose, chitin, chitosan or glycogen. Even more preferably the biopolymer is starch or cellulose. Most preferably the biopolymer is cellulose.

Cellulose is a linear polymer made up of 3-D-glucopyranose units covalently linked with 1-4 glycosidic bonds. Cellulose may be obtained from many different sources and the present disclosure is not necessarily limited as to the origin, form, or other characteristics of the cellulose. Cellulose is typically obtained from plant sources, for example from virgin or recycled wood pulp. Pulp is a lignocellulosic fibrous material prepared by chemically or mechanically separating cellulose fibers from wood, fiber crops, waste paper, or rags. Cellulose may be obtained from virgin sources or advantageously from recycled sources.

In some embodiments, the biopolymer is selected from the group consisting of virgin, recycled, pulp, and microcrystalline cellulose, and combinations thereof. In some embodiments, the biopolymer is virgin cellulose. In some embodiments, the biopolymer is recycled cellulose. In some embodiments, the biopolymer is pulp cellulose. Preferably, the biopolymer is microcrystalline cellulose.

Microcrystalline cellulose (MCC) is typically made from high-grade, purified wood cellulose. Hydrolysis is used to remove amorphous cellulose until the microcrystalline form remains. With its amorphous cellulose portions removed, it becomes an inert, white, free-flowing powder. It can be processed in a number of ways, for example through reactive extrusion, steam explosion, and acid hydrolysis. An example of a commercially available MCC is Avicel® produced by DuPont.

The term “particle” is used interchangeably herein with “bead” and refers to a solid formed following phase inversion of a dispersed phase droplet or extrusion of the dispersed phase into an anti-solvent.

The size of the biopolymer particles of the present disclosure is not limited. In various embodiments, the particles or beads are microparticles or microbeads. As would be understood by the person skilled in the art, microparticles or microbeads are particles/beads with a diameter between 1 and 1000 microns (μm). Such particles are readily identified by a person skilled in the art, for example, using an optical microscope image and image analysis software with a suitable detection algorithm (e.g. ImageJ using an edge detection algorithm), laser diffraction with commercially available equipment such as Mastersizer from Malvern Panalytical (e.g. Mastersizer 3000), or with an appropriately sized sieve. In other embodiments, the particles or beads may have a diameter greater than 1000 μm. Such particles may also be readily identified by a person skilled in the art using the equipment discussed above or by using a caliper.

There are various means by which particle size may be controlled and/or varied in the methods of the present disclosure. Non-limiting examples may include varying the flow rate and/or aperture/opening size in the extrusion process of the first aspect, or varying the pore size of the membrane and/or flow rate of the continuous phase in the membrane emulsification process of the second aspect. Such variation is understood by the person skilled in the art. In particular, the skilled person will understand that such variations might be implemented by varying, and/or be expressed in terms of, the Weber number (We) for the dispersed phase and/or the capillary number (Ca) of the continuous phase. The Weber number is defined as:

$$We = \frac{ρ {2}^{} ℓ}{σ}$$

where ρ is the density in kg m⁻³ and ν is the velocity of the dispersed phase in m s⁻¹, [symbol] is the characteristic length (droplet diameter or membrane pore diameter) in m, and σ is the interfacial tension in N m⁻¹. The capillary number is defined as:

$$Ca = \frac{μ V}{σ}$$

where μ is the dynamic viscosity in Ns m⁻² and V is the characteristic velocity in m s⁻¹ of the continuous phase, and σ is the interfacial tension between in N m⁻¹.

In some embodiments, the diameter of the biopolymer particles is from about 1 μm to about 500 μm. In some embodiments, the diameter of the biopolymer particles may be from about 1 μm to about 400 μm. In some embodiments, the diameter of the biopolymer particles is from about 1 μm to about 300 μm. In some embodiments, the diameter of the biopolymer particles is from about 1 μm to about 200 μm.

In some embodiments, the diameter of the biopolymer particles may be from about 0.2mm to about 3.0 mm. In some embodiments, the diameter of the biopolymer particles may be from about 0.2 mm to about 2.0 mm. In some embodiments, the diameter of the biopolymer particles may be from about 0.2 mm to about 1.0 mm.

In some embodiments, the diameter of the biopolymer particles may be from about 1 mm to about 10 mm. In some embodiments, the diameter of the biopolymer particles may be from about 1 mm to about 8 mm. In some embodiments, the diameter of the biopolymer particles may be from about 1 mm to about 5 mm.

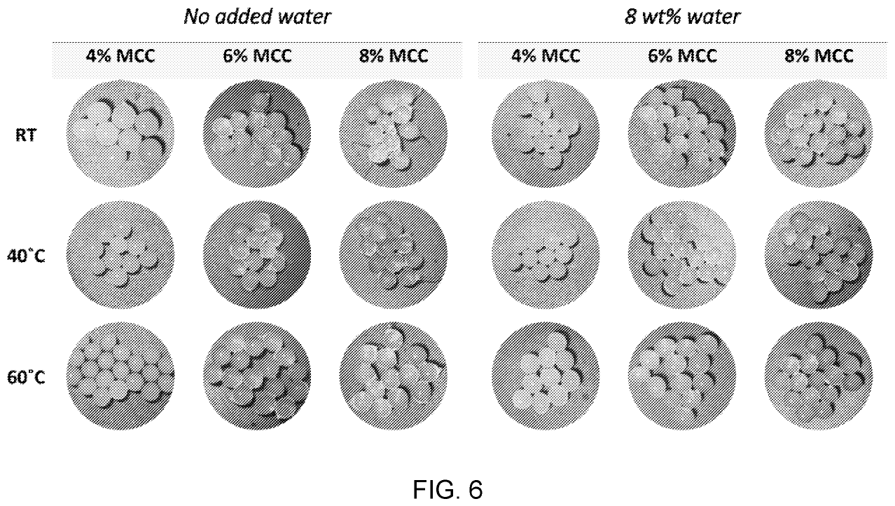

As discussed further below, the methods of the present disclosure may comprise removal of the biopolymer particles from the solvent/anti-solvent mixture or anti-solvent/continuous phase mixture. The particles obtained from the methods of the present disclosure may therefore be obtained in a form wherein said particles are wetted or immersed in a solvent such as water. Such particles may be referred to as “wet” beads and may be provided in this form for further use. Alternatively, the particles may be subsequently dried to provide “dry beads”. Both forms may find use in industrial applications and the present disclosure is not limited in this regard. Examples of wet and dry beads are shown in FIGS. 6 to 11.

### Dispersed Phase

Both aspects of the present disclosure involve a dispersed phase which comprises a solvent in which the biopolymer is dispersed or dissolved, which solvent comprises water. By the term “solvent” is therefore meant any substance (e.g. liquid) which disperses or dissolves the biopolymer. The term “solvent” also includes solvent mixtures.

The solvent of the dispersed phase comprises water and may comprise an ionic liquid, an organic solvent, an inorganic nonaqueous solvent, or a combination thereof. In various embodiments of the present disclosure, the solvent for the dispersed phase comprises water and at least one of an ionic liquid, an organic solvent, an inorganic nonaqueous solvent, or a combination thereof. In various embodiments of the present disclosure, the solvent for the dispersed phase comprises water and one or more ionic liquid(s).

Non-limiting examples of solvents for the dispersed phase other than water include methanol, ethanol, ammonia, acetone, acetic acid, n-propanol, n-butanol, isopropyl alcohol, ethyl acetate, dimethyl sulfoxide, sulfuryl chloride, phosphoryl chloride, carbon disulfide, morpholine, N-methylmorpholine, NaOH without and with association of urea and thiourea, bromine pentafluoride, hydrogen fluoride, sulfuryl chloride fluoride, acetonitrile, dimethylformamide, hydrocarbon oils and blends thereof, toluene, chloroform, carbon tetrachloride, benzene, hexane, pentane, cyclopentane, cyclohexane, 1,4-dioxane, dichloromethane, nitromethane, propylene carbonate, formic acid, tetrahydrofuran, diethyl ether, phosphoric acid, 1-ethyl-3-methylimidazolium acetate, 1-butyl-3-methylimidazolium chloride, 1-methoxymethyl-3-methylimidazolium bromide, N-ethylpyridinium chloride, N-methylmorpholine-N-oxide, 1-methylimidazole, N,N-dimethylformamide, N,N′-dimethylimidazolidin-2-one, N,N-dimethylacetamide, sulfolane, γ-valerolactone, γ-butyrolactone, N,N,N′,N′-tetramethylurea, N-methylpyrrolidinone, and methylene chloride. The skilled person will readily recognise which of the exemplary solvents are ionic liquids, organic solvents, and/or inorganic non-aqueous solvents.

As will be understood by the skilled person in the art, the dispersed phase will depend on the biopolymer being used. The identification of suitable solvents for the dispersed phase of the present disclosure is specifically within the common general knowledge of the skilled person. In all aspects of the present disclosure, however, the solvent for the dispersed phase comprises water. Water may be considered by a person skilled in the art to be an effective anti-solvent for certain biopolymers, e.g. cellulose, on its own or in mixtures with other solvents. However, water comprised in the solvent for the dispersed phase of the present disclosure is considered for the purposes of the present disclosure as being distinct from the anti-solvent used in the aspects of the present disclosure.

In various embodiments, the solvent of the dispersed phase comprises at least about 0.5 wt % water. In various embodiments, the solvent of the dispersed phase comprises at least about 1 wt % water. In various embodiments, the solvent of the dispersed phase comprises at least about 1.5 wt % water. In various embodiments, the solvent of the dispersed phase comprises at least about 2 wt % water. In various embodiments, the solvent of the dispersed phase comprises at least about 2.5 wt % water. In various embodiments, the solvent of the dispersed phase comprises at least about 3 wt % water. In various embodiments, the solvent of the dispersed phase comprises at least about 3.5 wt % water. In various embodiments, the solvent of the dispersed phase comprises at least about 4 wt % water. In various embodiments, the solvent of the dispersed phase comprises at least about 4.5 wt % water. In various embodiments, the solvent of the dispersed phase comprises at least about 5 wt % water. In various embodiments, the solvent of the dispersed phase comprises at least about 5.5 wt % water. In various embodiments, the solvent of the dispersed phase comprises at least about 6 wt % water. In various embodiments, the solvent of the dispersed phase comprises at least about 6.5 wt % water. In various embodiments, the solvent of the dispersed phase comprises at least about 7 wt % water. In various embodiments, the solvent of the dispersed phase comprises at least about 7.5 wt % water. In various embodiments, the solvent of the dispersed phase comprises at least about 8 wt % water.

In various embodiments of the present disclosure, the solvent of the dispersed phase includes an minimum amount of water as defined in the preceding paragraph (e.g. at least about 0.5 wt %) where the maximum water content is determined by a maximum viscosity for the dispersed phase at the temperature at which the dispersed phase is either extruded in the first aspect or passed through a membrane in the second aspect, the maximum viscosity for the dispersed phase being defined by the viscosity of a reference solution at a predetermined temperature and shear rate.

Viscosity is measured using a rheometer, for example a Discovery HR-3 hybrid rheometer (TA Instruments) fitted with a 40 mm stainless steel parallel plate. The gap is set to 500 μm and the sample sealed with mineral oil to prevent moisture migration. A logarithmic shear rate sweep is performed from 0.1 to 100 s⁻¹ (10 points per decade) with a 10 second temperature soak at the temperature at which viscosity is to be measured prior to measurement. The viscosity is recorded from the Newtonian region at 1 s⁻¹.

In various embodiments, the maximum water content is that which results in a viscosity of the dispersed phase at the temperature at which the dispersed phase is either extruded in the first aspect or passed through a membrane in the second aspect which is equal to or less than the viscosity of a reference solution of x wt % biopolymer in a 70:30 mixture of DMSO:non-aqueous solvent at room temperature using the above measurement method. x is greater than or equal to the biopolymer concentration in the dispersed phase of the invention, and the biopolymer is the same in both the reference solution and dispersed phase of the invention. The non-aqueous solvent is the solvent of the dispersed phase other than water (including any optional components discussed below).

A lower biopolymer concentration in a solvent of water and an ionic liquid can, for instance, be expected to give rise to a lower viscosity at a given temperature and shear rate compared to a higher biopolymer concentration, and thereby withstand a higher water content in the dispersed phase solvent. Hence, the water concentration is disclosed above by a lower limit or minimum content only. The skilled person is readily able to determine the maximum water content from the disclosure herein and it would unduly restrict the scope of the present disclosure to limit the maximum water content to an absolute value.

The degree of polymerisation of the biopolymer can also be expected to influence the viscosity of the dispersed phase. The degree of polymerisation is the number of monomer units in the biopolymer and may be calculated as the ratio of the number average molecular weight of the biopolymer and the molecular weight of the repeat unit. A higher degree of polymerisation results in more chain entanglement in solution, giving a higher viscosity. Microcrystalline cellulose typically has a degree of polymerisation of about 200 to about 400. Avicel® is specified to have a degree of polymerisation of less than 350.

In various embodiments of the present disclosure, the biopolymer has a degree of polymerisation of less than about 400. In various embodiments of the present disclosure, the biopolymer has a degree of polymerisation of less than about 350. In various embodiments of the present disclosure, the biopolymer has a degree of polymerisation of between about 50 to about 400. In various embodiments of the present disclosure, the biopolymer has a degree of polymerisation of between about 100 to about 400. In various embodiments of the present disclosure, the biopolymer has a degree of polymerisation of between about 150 to about 400. In various embodiments of the present disclosure, the biopolymer has a degree of polymerisation of between about 200 to about 400, e.g. about 200 to about 350.

A reference solution of 8 wt % microcrystalline cellulose in a 70:30 mixture of DMSO:EmimOAc is disclosed in James Coombs OBrien et al., Continuous Production of Cellulose Microbeads via Membrane Emulsification. ACS Sustainable Chemistry & Engineering 2017 5 (7), 5931-5939, incorporated herein by reference. This is the reference solution used in the Examples below. It has a viscosity at room temperature and 1 s⁻¹ shear rate of 1.89 Pa·s, as measured by the above-mentioned method, and this viscosity is used to determine the maximum water content for dispersed phases containing 4, 6 or 8 wt % MCC in EmimOAc being used at temperatures of 30° C. to 60° C. in the extrusion process. The dropping height can also be varied to control the sphericity of the beads as discussed in more detail below.

Notwithstanding that an upper limit on water content would unduly restrict the scope of the present disclosure, in various embodiments the solvent of the dispersed phase comprises from about 0.5 wt % to about 12 wt % water. In various embodiments the solvent comprises from about 1 wt % to about 12 wt % water. In various embodiments the solvent comprises from about 1.5 wt % to about 12 wt % water. In various embodiments the solvent comprises from about 2 wt % to about 12 wt % of water. In various embodiments, the solvent comprises from about 2.5 wt % to about 12 wt % of water. In various embodiments, the solvent comprises from about 3 wt % to about 12 wt % of water. In various embodiments, the solvent comprises from about 3.5 wt % to about 12 wt % of water. In various embodiments, the solvent comprises from about 4 wt % to about 12 wt % of water. In various embodiments, the solvent comprises from about 4.5 wt % to about 12 wt % of water. In various embodiments, the solvent comprises from about 5 wt % to about 12 wt % of water. In various embodiments, the solvent comprises from about 5.5 wt % to about 12 wt % of water. In various embodiments, the solvent comprises from about 6 wt % to about 12 wt % of water.

In various embodiments, the solvent comprises from about 0.5 wt % to about 10 wt % water. In various embodiments the solvent comprises from about 1 wt % to about 10 wt % water. In various embodiments the solvent comprises from about 1.5 wt % to about 10 wt % water. In various embodiments the solvent comprises from about 2 wt % to about 10 wt % of water. In various embodiments the solvent comprises from about 2.5 wt % to about 10 wt % of water. In various embodiments the solvent comprises from about 3 wt % to about 10 wt % of water. In various embodiments the solvent comprises from about 3.5 wt % to about 10 wt % of water. In various embodiments, the solvent comprises from about 4 wt % to about 10 wt % of water. In various embodiments the solvent comprises from about 4.5 wt % to about 10 wt % of water. In various embodiments the solvent comprises from about 5 wt % to about 10 wt % of water. In various embodiments the solvent comprises from about 5.5 wt % to about 10 wt % of water. In various embodiments, the solvent comprises from about 6 wt % to about 10 wt % of water.

In various embodiments, the solvent for the dispersed phase comprises water and an ionic liquid. The ionic liquid may be selected from 1-ethyl-3-methylimidazolium acetate (EmimOAc), 1-butyl-3-methylimidazolium chloride (BmimOAc), and a combination thereof. In some embodiments, the solvent for the dispersed phase comprises water and one or more organic solvents. In other embodiments, the solvent for the dispersed phase is substantially free of organic solvents. The term “substantially free” is defined above. The skilled person will understand that when the solvent of the dispersed phase consists of water and an ionic liquid, the total wt % of water and ionic liquid in the dispersed phase solvent will total 100 wt %. If water is present, for example, in an amount of at least 0.5 wt %, an ionic liquid may be present in an amount of at least 99.5 wt %, with the proviso that the total of water and ionic liquid is 100 wt %. In other words, the ionic liquid may be present as the remainder of the solvent.

Preferably, the solvent used for the dispersed phase is environmentally friendly. By the term “environmentally friendly” is meant not harmful to the environment such that the solvent can be disposed of without the need for specialist equipment or process(es), i.e. non-toxic. It is known in the art that polysaccharides have limited dissolution in most of the common solvents. It is also known in the art that those solvents which do dissolve polysaccharides are often toxic and/or highly selective. When the biopolymer is a polysaccharide such as cellulose, starch, chitin, glycogen, and/or chitosan, the solvent for the dispersed phase may therefore comprise an ionic liquid in addition to water. The dissolution of cellulose with the ionic liquid 1-butyl-3-methylimidazolium chloride is, for example, discussed in Richard et al., J. Am. Chem. Soc. 2002, 124, 4974-4975. Verma et al., Sustainable Chemistry and Pharmacy 13 (2019), 100162 similarly discusses the solubility of cellulose in ionic liquids and ionic liquids with co-solvents. Each of these disclosures is incorporated herein by reference.

The concentration of biopolymer in the dispersed phase is not limited and may be any concentration suitable for the methods of the present disclosure. In various embodiments, the biopolymer is present in the dispersed phase in an amount from about 0.1 wt % to about 15wt %. In various embodiments the biopolymer is present in the dispersed phase in an amount from about 0.5 wt % to about 15 wt %. In various embodiments the biopolymer is present in the dispersed phase in an amount from about 1 wt % to about 15 wt %. In various embodiments the biopolymer is present in the dispersed phase in an amount from about 1.5 wt % to about 15 wt %. In various embodiments the biopolymer is present in the dispersed phase in an amount from about 2 wt % to about 15 wt %. In various embodiments the biopolymer is present in the dispersed phase in an amount from about 2.5 wt % to about 15 wt %. In various embodiments the biopolymer is present in the dispersed phase in an amount from about 3 wt % to about 15 wt %. In various embodiments the biopolymer is present in the dispersed phase in an amount from about 3.5 wt % to about 15 wt %. In various embodiments the biopolymer is present in the dispersed phase in an amount from about 4 wt % to about 15 wt %.

In various embodiments, the biopolymer is present in the dispersed phase in an amount from about 0.1 wt % to about 12 wt %. In various embodiments, the biopolymer is present in the dispersed phase in an amount from about 0.5 wt % to about 12 wt %. In various embodiments, the biopolymer is present in the dispersed phase in an amount from about 1 wt % to about 12 wt %. In various embodiments, the biopolymer is present in the dispersed phase in an amount from about 1.5 wt % to about 12 wt %. In various embodiments, the biopolymer is present in the dispersed phase in an amount from about 2 wt % to about 12 wt %. In various embodiments, the biopolymer is present in the dispersed phase in an amount from about 2.5 wt % to about 12 wt %. In various embodiments, the biopolymer is present in the dispersed phase in an amount from about 3 wt % to about 12 wt %. In various embodiments, the biopolymer is present in the dispersed phase in an amount from about 3.5 wt % to about 12 wt %. In various embodiments, the biopolymer is present in the dispersed phase in an amount from about 4 wt % to about 12 wt %.

In various embodiments, the biopolymer is present in the dispersed phase in an amount from about 0.1 wt % to about 10 wt %. In various embodiments, the biopolymer is present in the dispersed phase in an amount from about 0.5 wt % to about 10 wt %. In various embodiments, the biopolymer is present in the dispersed phase in an amount from about 1 wt % to about 10 wt %. In various embodiments, the biopolymer is present in the dispersed phase in an amount from about 1.5 wt % to about 10 wt %. In various embodiments, the biopolymer is present in the dispersed phase in an amount from about 2 wt % to about 10 wt %. In various embodiments, the biopolymer is present in the dispersed phase in an amount from about 2.5 wt % to about 10 wt %. In various embodiments, the biopolymer is present in the dispersed phase in an amount from about 3 wt % to about 10 wt %. In various embodiments, the biopolymer is present in the dispersed phase in an amount from about 3.5 wt % to about 10 wt %. In various embodiments, the biopolymer is present in the dispersed phase in an amount from about 4 wt % to about 10 wt %.

The dispersed phase may further include optional components. These optional components include, but are not limited to, surfactants, porogens, active ingredients, pockets of air, double emulsions, pigments, and dyes. The level of any of the optional components is not significant in the present disclosure. In various embodiments, the dispersed phase includes a co-solvent.

The surfactant may be any suitable surfactant known in the art, for example, any ionic or non-ionic surfactant. Ionic surfactants may include sulfates, sulfonates, phosphates and carboxylates such as alkyl sulfates, ammonium lauryl sulfates, sodium lauryl sulfates, alkyl ether sulfates, sodium laureth sulfate and sodium myreth sulfate, dioctyl sodium sulfosuccinate, perfluorooctanesulfonate, perfluorobutanesulfonate, alkyl benzene sulfonates, alkyl aryl ether phosphates, alkyl ether phosphates, and alkyl carboxylates. Non-ionic surfactants may include polyethers, polyoxyalkylene derivatives of hexitol, partial long-chain fatty acid esters such as sorbitan oleates, ethylene oxide derivatives of long-chain alcohols, ethoxylated vegetable oil, polydimethylsilxoxanes, and ethylene oxide/propylene oxide copolymers.

The temperature of the dispersed phase is not limited, although in various embodiments it may be controlled to ensure the viscosity of the dispersed phase is no greater than a maximum value as discussed above. The temperature may, for instance, be controlled to ensure that the dispersed phase comprising a certain concentration of biopolymer and certain concentration of water has the maximum viscosity discussed above (namely of a reference solution at a specified temperature and shear rate (e.g. ambient temperature and 1 s⁻¹ shear)). The relationship between these features is discussed herein including in the Examples below.

By the expression “temperature of the dispersed phase” or “the dispersed phase is at a temperature of”, or the like, is meant the temperature of the dispersed phase prior to extrusion or membrane emulsification (e.g. when it is placed in the apparatus for such extrusion or emulsification), and/or the temperature of the apparatus during extrusion or emulsification of the dispersed phase. As discussed in more detail below, the extrusion or emulsification means may be heated so that the dispersed phase remains at an elevated temperature in situ. Preferably the extrusion means is heated directly by one or more heating means. This is discussed further below.

In some embodiments, the dispersed phase is at ambient or room temperature, namely between about 20 and about 25° C. In various embodiments the dispersed phase is heated above ambient temperature. The dispersed phase may be heated using any suitable means. The dispersed phase is preferably heated in situ such that there is no temperature loss prior to extrusion or membrane emulsification, for example by heating a vessel containing the dispersed phase and/or the extrusion or emulsification means. In the extrusion process, a heated syringe and/or needle may, for example, be used. Suitable heating apparatus may comprise a heating element, for example a Peltier element, as well as a means of regulating the temperature, such as a thermocouple and controller.

Thus, in various embodiments, the temperature of the dispersed phase is from about 5° C. to less than about 100° C., from about 10° C. to less than about 100° C., from about 15° C. to less than about 100° C., from about 20° C. to less than about 100° C., from about 25° C. to less than about 100° C., or from about 30°° C. to less than about 100° C. The maximum temperature will be set by the point at which the evaporation of water from the dispersed phase becomes prohibitive and/or decomposition of the ionic liquid begins to occur. This will readily be determined by the person skilled in the art.

In various embodiments, the temperature of the dispersed phase is from about 5° C. to about 90° C., from about 10° C. to about 90° C., from about 15° C. to about 90° C., from about 20° C. to about 90° C., from about 25° C. to about 90° C., or from about 30° C. to about 90° C. In various embodiments, the temperature of the dispersed phase is from about 5° C. to about 80° C., from about 10° C. to about 80° C., from about 15° C. to about 80° C., from about 20° C. to about 80° C., from about 25° C. to about 80° C., from about 30° C. to about 80° C., or from about 40° C. to about 80° C.

An object of the present disclosure is to produce biopolymer particles with good sphericity. In this regard, the inventors have found that the temperature of the dispersed phase and the amount of biopolymer in the dispersed phase may be advantageous. Thus, the above disclosure of biopolymer concentrations may be combined with the disclosure of the water content and optionally the dispersed phase temperature.

In some embodiments, the biopolymer is present in the dispersed phase in an amount from about 0.5 wt % to about 12 wt % and the solvent comprises at least about 0.5 wt % water. As described above, the maximum water content should be determined based on the maximum viscosity of the dispersed phase. In some embodiments, the biopolymer is present in the dispersed phase in an amount from about 1 wt % to about 12 wt % and the solvent comprises at least about 0.5 wt % water. In some embodiments, the biopolymer is present in the dispersed phase in an amount from about 1.5 wt % to about 12 wt % and the solvent comprises at least about 0.5 wt % water. In some embodiments, the biopolymer is present in the dispersed phase in an amount from about 2 wt % to about 12 wt % and the solvent comprises at least about 0.5 wt % water. In some embodiments, the biopolymer is present in the dispersed phase in an amount from about 2.5 wt % to about 12 wt % and the solvent comprises at least about 0.5 wt % water. In some embodiments, the biopolymer is present in the dispersed phase in an amount from about 3 wt % to about 12 wt % and the solvent comprises at least about 0.5 wt % water. Each of these biopolymer concentration ranges can be combined with the above water content ranges, e.g. from about 0.5 wt % to about 12 wt %.

In some embodiments, the biopolymer is present in the dispersed phase in an amount from about 2 wt % to about 10 wt % and the solvent comprises at least about 1 wt % water. As described above, the maximum water content should be determined based on the maximum viscosity of the dispersed phase. In some embodiments, the biopolymer is present in the dispersed phase in an amount from about 3 wt % to about 10 wt % and the solvent comprises at least about 1 wt % water. In some embodiments, the biopolymer is present in the dispersed phase in an amount from about 4 wt % to about 10 wt % and the solvent comprises at least about 1 wt % water. Each of these biopolymer concentration ranges can be combined with the above water content ranges, e.g. from about 1 wt % to about 12 wt %.

In some embodiments, the biopolymer is present in the dispersed phase in an amount from about 0.5 wt % to about 12 wt % and the solvent comprises at least about 0.5 wt % water and the temperature of the dispersed phase is from about 5° C. to about 80° C. (including ambient to 80° C.). As described above, the maximum water content should be determined based on the maximum viscosity of the dispersed phase. In some embodiments, the biopolymer is present in the dispersed phase in an amount from about 1 wt % to about 12 wt % and the solvent comprises at least about 0.5 wt % water and the temperature of the dispersed phase is from about 5° C. to about 80° C. (including ambient to 80° C.). In some embodiments, the biopolymer is present in the dispersed phase in an amount from about 1.5 wt % to about 12 wt % and the solvent comprises at least about 0.5 wt % water and the temperature of the dispersed phase is from about 5° C. to about 80° C. (including ambient to 80° C.). In some embodiments, the biopolymer is present in the dispersed phase in an amount from about 2 wt % to about 12 wt % and the solvent comprises at least about 0.5 wt % water and the temperature of the dispersed phase is from about 5° C. to about 80° C. (including ambient to 80° C.). In some embodiments, the biopolymer is present in the dispersed phase in an amount from about 2.5 wt % to about 12 wt % and the solvent comprises at least about 0.5 wt % water and the temperature of the dispersed phase is from about 5° C. to about 80° C. (including ambient to 80° C.). In some embodiments, the biopolymer is present in the dispersed phase in an amount from about 3 wt % to about 12 wt % and the solvent comprises at least about 0.5 wt % water and the temperature of the dispersed phase is from about 5° C. to about 80° C. (including ambient to 80° C.). Each of these biopolymer concentration and dispersed phase temperature ranges can be combined with the above water content ranges, e.g. from about 0.5 wt % to about 12 wt %. Similarly each of these biopolymer concentration and water content ranges can be combined with the above dispersed phase temperature ranges, e.g. from about 30° C. to about 70° C. and the like.

In some embodiments, the biopolymer is present in the dispersed phase in an amount from about 2 wt % to about 10 wt % and the solvent comprises at least about 1 wt % water and the temperature of the dispersed phase is from about 5° C. to about 80° C. (including ambient to 80° C.). As described above, the maximum water content should be determined based on the maximum viscosity of the dispersed phase. In some embodiments, the biopolymer is present in the dispersed phase in an amount from about 3 wt % to about 10 wt % and the solvent comprises at least about 1 wt % water and the temperature of the dispersed phase is from about 5° C. to about 80° C. (including ambient to 80° C.). In some embodiments, the biopolymer is present in the dispersed phase in an amount from about 4 wt % to about 10 wt % and the solvent comprises at least about 1 wt % water and the temperature of the dispersed phase is from about 5° C. to about 80° C. (including ambient to 80° C.). Each of these biopolymer concentration ranges can be combined with the above water content ranges, e.g. from about 1 wt % to about 12 wt %. Similarly each of these biopolymer concentration and water content ranges can be combined with the above dispersed phase temperature ranges, e.g. from about 30° C. to about 70° C. and the like.

In some embodiments, the biopolymer is present in the dispersed phase in an amount from 2 wt % to about 12 wt %, the solvent comprises from about 2 wt % to about 12 wt % of water, and the temperature of the dispersed phase is from about 5° C. to about 80° C. (including ambient to 80° C.). In some embodiments, the biopolymer is present in the dispersed phase in an amount from 2 wt % to about 12 wt %, the solvent comprises from about 4 wt % to about 10 wt % of water, and the temperature of the dispersed phase is from about 5° C. to about 80° C. (including ambient to 80° C.).

In some embodiments, the biopolymer is present in the dispersed phase in an amount from 4 wt % to about 10 wt %, the solvent comprises from about 2 wt % to about 12 wt % of water, and the temperature of the dispersed phase is from about 5° C. to about 80° C. (including ambient to 80° C.). In some embodiments, the biopolymer is present in the dispersed phase in an amount from 4 wt % to about 10 wt %, the solvent comprises from about 4 wt % to about 10wt % of water, and the temperature of the dispersed phase is from about 5° C. to about 80° C. (including ambient to 80° C.).

### Anti-Solvent

In all aspects of the present disclosure, the anti-solvent comprises water, i.e. it is aqueous. In various embodiments, the anti-solvent may comprise water and an organic solvent such as an alcohol or acetone, or any other organic solvent known in the art. Suitable alcohols include ethanol and/or methanol. Preferably, the anti-solvent of the present disclosure is environmentally friendly. More preferably, the solvent and anti-solvent of the present disclosure are both environmentally friendly. Thus, in various embodiments, the anti-solvent is substantially free of organic solvents. In various embodiments, the anti-solvent is or consists of water.

In various embodiments, the anti-solvent further comprises an ionic liquid. In some embodiments, the anti-solvent may comprise water and an ionic liquid before phase inversion or extrusion of the dispersed phase. In other embodiments, the ionic liquid may be introduced into the anti-solvent during the phase inversion or extrusion. In some embodiments where the dispersed phase comprises an ionic liquid, the ionic liquid may be introduced into the anti-solvent from the dispersed phase during the phase inversion or extrusion process.

In various embodiments, the concentration of ionic liquid in the anti-solvent is up to about 50 wt %—the term “up to” being understood to mean greater than zero. In various embodiments the concentration of ionic liquid in the anti-solvent is up to about 40 wt %. In various embodiments the concentration of ionic liquid in the anti-solvent is up to about 30 wt %. In various embodiments the concentration of ionic liquid in the anti-solvent is up to about 20 wt %. In various embodiments the concentration of ionic liquid in the anti-solvent is up to about 10 wt %.

Where the anti-solvent comprises water and an ionic liquid, the ionic liquid may be 1-ethyl-3-methylimidazolium acetate (EmimOAc), 1-butyl-3-methylimidazolium chloride (BmimOAc), or mixtures thereof. In various embodiments, the ionic liquid is 1-ethyl-3-methylimidazolium acetate (EmimOAc).

The temperature of the anti-solvent is not limited, particularly in the extrusion process of the present disclosure. In various embodiments, the temperature of the anti-solvent is from about 5° C. to about 80° C. In various embodiments, the temperature of the anti-solvent is from about 10° C. to about 70° C. In various embodiments the temperature of the anti-solvent is from about 15° C. to about 60° C.

In various embodiments of the membrane emulsification process of the present disclosure, the temperature of the anti-solvent is ambient such that phase inversion is carried out at ambient temperature, namely between about 20 and about 25° C. In such embodiments, the anti-solvent has a temperature between about 20 and about 25° C. Alternatively and preferably, the anti-solvent is cooled to a temperature below ambient temperature, namely below about 20° C. For example, in some embodiments of the second aspect, the anti-solvent may be cooled to a temperature T₂, for the phase inversion (b), T₂ being less than T_{disp}. Preferably T₂ is substantially equal to T₁, more preferably T₂ is equal to T₁, where T₁ is defined above.

The advantage of controlling the temperature of the anti-solvent (T₂) in such embodiments is to prevent pre-mature thawing of the frozen droplets. Without wishing to be bound by any one theory, the inventors believe that by cooling the anti-solvent to T₂, the droplets remain in a frozen state (and hence spherical and non-aggregated) whilst the continuous phase surrounding them is stripped away by the phase inversion. The anti-solvent is able to contact the surface of the droplets, causing precipitation of the biopolymer and hardening of the precipitate surface. Additionally, as the frozen dispersed phase droplet thaws, the anti-solvent will convert the droplet of dissolved biopolymer to a bead/particle thereof, whilst leaching the solvent system into the anti-solvent.

### Extrusion

In the first aspect of the present disclosure, the dispersed phase is extruded into the anti-solvent to form particles of the biopolymer. In various embodiments, the dispersed phase is extruded through a fluid medium by capillary extrusion. The fluid medium may, for example, be air. Examples of capillaries through which the dispersed phase may be extruded are glass capillaries, microfluidic channels, and (hypodermic) needles. The material from which such capillaries are prepared is not limited and the skilled person will be able to select suitable capillaries compatible with the dispersed phase.

The surface of the capillary may also be modified. The capillary may, for example, be treated, coated, or lined, in order to alter its wetting properties. Such modifications of the capillary material may, for example, alter the hydrophilicity/hydrophobicity of the capillary material, thereby altering the wettability of the capillary surface. Capillaries may, for example, be treated with reactive hydrophobic compounds such as silanes to form a hydrophobic surface layer, or hydrophobic compounds may be deposited onto a capillary surface by methods such as chemical vapour deposition. In another example, metal needles may be lined with PTFE (polytetrafluoroethylene). The identification of suitable surface modifications is specifically within the common general knowledge of the skilled person. Such surface modifications may vary the size of the biopolymer particles obtained by the methods disclosed herein and/or may improve the regularity of size and shape of said particles.

The size of the aperture or opening, e.g. the diameter of the capillary or the gauge of the needle, is not limited. It will be immediately apparently to a person skilled in the art that the size of the aperture or opening will, however, influence the size of the droplets of the dispersed phase extruded therefrom. Generally, a larger aperture or opening would be expected to produce larger droplets of the dispersed phase, and conversely a smaller aperture or opening would be expected to produce smaller droplets of the dispersed phase. The skilled person will be able to select appropriately sized openings/apertures.

The diameter of the aperture or opening through which the dispersed phase is extruded may be less than about 3 mm, less than about 2.5 mm, less than about 2 mm, less than about 1.5 mm, less than about 1 mm, less than about 0.75 mm, less than about 0.5 mm, less than about 0.4 mm, less than about 0.3 mm, or less than about 0.2 mm. In various embodiments, the diameter of the aperture or opening through which the dispersed phase is extruded may be greater than about 0.1 mm. In various embodiments, the diameter of the aperture or opening through which the dispersed phase is extruded may be greater than about 0.1 mm and less than about 3 mm, greater than about 0.1 mm and less than about 2.5 mm, greater than about 0.1 mm and less than about 2 mm, greater than about 0.1 mm and less than about 1.5 mm, greater than about 0.1 mm and less than about 1 mm, greater than about 0.1 mm and less than about 0.75 mm, greater than about 0.1 mm and less than about 0.5 mm, greater than about 0.1 mm and less than about 0.4 mm, or greater than about 0.1 mm and less than about 0.3 mm. In other embodiments, the diameter of the aperture or opening through which the dispersed phase is extruded may be from about 0.1 mm to about 1 mm, from about 1 mm to about 2 mm, or from about 2 mm to about 3 mm.

In various embodiments, the dispersed phase is extruded through a needle. The needle may be blunt-tipped, although the present disclosure is not limited in this respect. In various embodiments, the needle gauge size is 34, 33, 32, 31, 30, 29, 28, 27, 26, 25, 24, 23, 22, 21, 20, 19, 18, 17, 16, 15, 14, 13, 12, 11, or 10 gauge.

The rate of extrusion is not limited and may be controlled using standard laboratory equipment, for example a syringe pump. In various embodiments, the rate of extrusion is less than about 1 mL/min, less than about 100 μL/min, less than about 10 μL/min, less than about 1 μL/min, or less than about 100 nL/min. In other embodiments, the rate of extrusion is from about 1 μL/min to about 1 mL/min, or from about 10 μL/min to about 100 μL/min.

In some embodiments of the first aspect, the dispersed phase is first extruded through a fluid medium into a mould and then the extruded dispersed phase is contacted with the anti-solvent. In various embodiments, the mould may impart a shape to the biopolymer particles formed upon contacting the extruded dispersed phase with the anti-solvent. The shape of the biopolymer particles is not limited, and will be determined by the shape of the mould in this instance. The mould may be formed of any suitable material that is compatible with the dispersed phase and anti-solvent, and may, for example, be a silicone polymer such as polydimethylsiloxane (PDMS). The mould may be prepared by casting the mould material, or may be prepared by 3D printing the mould material. The extruded dispersed phase may be contacted with the anti-solvent by submerging the mould containing the extruded dispersed phase in the anti-solvent. The mould may be removed after the biopolymer particles have formed, or may be retained during further processing steps, such as washing and filtration/extraction of the biopolymer particles.

When a mould is not used, extrusion may occur within the anti-solvent; that is to say, the dispersed phase may be exposed to the anti-solvent immediately upon extrusion (for example where the aperture or opening is submerged in the anti-solvent). Alternatively, and preferably, in various embodiments the extruded dispersed phase is dropped from a height above the surface of the anti-solvent. This can be seen in FIG. 1, wherein the extruded dispersed phase is dropped from a height, d, above the surface of the anti-solvent.

The dropping height may influence the sphericity of the particles obtained by the extrusion process. Without wishing to be bound by any one theory, it is believed that a greater dropping height may minimize tailing (i.e. improve sphericity) by allowing more time for cohesive forces to act on the falling droplet. Thus, in various embodiments, the extruded phase is dropped from a height of at least 10 cm above the surface of the anti-solvent. In various embodiments the extruded phase is dropped from a height of at least 20 cm above the surface of the anti-solvent. In various embodiments the extruded phase is dropped from a height of at least 30 cm above the surface of the anti-solvent. In various embodiments the extruded phase is dropped from a height of at least 40 cm above the surface of the anti-solvent. In various embodiments the extruded phase is dropped from a height of at least 50 cm above the surface of the anti-solvent. In various embodiments the extruded phase is dropped from a height of at least 60 cm above the surface of the anti-solvent. In various embodiments the extruded phase is dropped from a height of at least 70 cm above the surface of the anti-solvent, or at least 80cm above the surface of the anti-solvent.

The maximum dropping height will be determined by the distance at which non-spherical particles are formed. This is known in the art and readily understood by the skilled person. It may, for instance, be determined by eye. In various embodiments, however, the extruded phase is dropped from a height of less than 80 cm above the surface of the anti-solvent. In various embodiments, the extruded phase is dropped from a height of less than 70 cm above the surface of the anti-solvent. In various embodiments, the extruded phase is dropped from a height of In various embodiments, the extruded phase is dropped from a height of less than 60 cm above the surface of the anti-solvent. In various embodiments, the extruded phase is dropped from a height of less than 50 cm above the surface of the anti-solvent.

In various embodiments the extruded phase is dropped from a height of about 1 cm to about 80 cm above the surface of the anti-solvent, preferably from a height of about 5 cm to about 70 cm, more preferably from a height of about 10 cm to about 60 cm.

In various embodiments the extruded phase is dropped from a height of about 10 cm to about 80 cm above the surface of the anti-solvent. In various embodiments the extruded phase is dropped from a height of about 10 cm to about 70 cm above the surface of the anti-solvent. In various embodiments the extruded phase is dropped from a height of about 10 cm to about 60 cm above the surface of the anti-solvent. In various embodiments the extruded phase is dropped from a height of about 10 cm to about 50 cm above the surface of the anti-solvent.

In various embodiments the extruded phase is dropped from a height of about 20 cm to about 80 cm above the surface of the anti-solvent. In various embodiments the extruded phase is dropped from a height of about 20 cm to about 70 cm above the surface of the anti-solvent. In various embodiments the extruded phase is dropped from a height of about 20 cm to about 60 cm above the surface of the anti-solvent. In various embodiments the extruded phase is dropped from a height of about 20 cm to about 50 cm above the surface of the anti-solvent. In various embodiments the extruded phase is dropped from a height of about 20 cm to about 40 cm above the surface of the anti-solvent.

As already discussed above, the sphericity of the biopolymer particles may also be influenced by the temperature of the dispersed phase and the amount of biopolymer in the dispersed phase. Accordingly, in the method of the first aspect, the sphericity of the biopolymer particles may be influenced by one or more of the dropping height, the temperature of the dispersed phase; and the amount of biopolymer in the dispersed phase for a given water content in the solvent in the dispersed phase.

In some embodiments, the biopolymer is present in the dispersed phase in an amount from about 0.5 wt % to about 12 wt %, the solvent comprises at least about 0.5 wt % water, and the extruded dispersed phase is dropped from a height of about 10 cm to about 70 cm. As described above, the maximum water content should be determined based on the maximum viscosity of the dispersed phase. In some embodiments, the biopolymer is present in the dispersed phase in an amount from about 1 wt % to about 12 wt %, the solvent comprises at least about 0.5 wt % water, and the extruded dispersed phase is dropped from a height of about 10 cm to about 70 cm. In some embodiments, the biopolymer is present in the dispersed phase in an amount from about 1.5 wt % to about 12 wt %, the solvent comprises at least about 0.5 wt % water, and the extruded dispersed phase is dropped from a height of about 10 cm to about 70 cm. In some embodiments, the biopolymer is present in the dispersed phase in an amount from about 2 wt % to about 12 wt %, the solvent comprises at least about 0.5 wt % water, and the extruded dispersed phase is dropped from a height of about 10 cm to about 70 cm. In some embodiments, the biopolymer is present in the dispersed phase in an amount from about 2.5 wt % to about 12 wt %, the solvent comprises at least about 0.5 wt % water, and the extruded dispersed phase is dropped from a height of about 10 cm to about 70 cm. In some embodiments, the biopolymer is present in the dispersed phase in an amount from about 3 wt % to about 12 wt %, the solvent comprises at least about 0.5 wt % water, and the extruded dispersed phase is dropped from a height of about 10 cm to about 70 cm. Each of these biopolymer concentration ranges can be combined with the above water content ranges, e.g. from about 0.5 wt % to about 12 wt % and/or the above dropping height ranges, e.g. about 10 cm to about 60 cm or about 20 cm to about 50 cm.

In some embodiments, the biopolymer is present in the dispersed phase in an amount from about 2 wt % to about 10 wt %, the solvent comprises at least about 1 wt % water, and the extruded dispersed phase is dropped from a height of about 10 cm to about 70 cm. As described above, the maximum water content should be determined based on the maximum viscosity of the dispersed phase. In some embodiments, the biopolymer is present in the dispersed phase in an amount from about 3 wt % to about 10 wt %, the solvent comprises at least about 1 wt % water, and the extruded dispersed phase is dropped from a height of about 10 cm to about 70 cm. In some embodiments, the biopolymer is present in the dispersed phase in an amount from about 4 wt % to about 10 wt %, the solvent comprises at least about 1 wt % water, and the extruded dispersed phase is dropped from a height of about 10 cm to about 70 cm. Each of these biopolymer concentration ranges can be combined with the above water content ranges, e.g. from about 1 wt % to about 12 wt %, and/or the above dropping height ranges, e.g. about 10 cm to about 60 cm or about 20 cm to about 50 cm.

In some embodiments, the biopolymer is present in the dispersed phase in an amount from about 0.5 wt % to about 12 wt %, the solvent comprises at least about 0.5 wt % water, the temperature of the dispersed phase is from about 30° C. to about 80° C., and the extruded dispersed phase is dropped from a height of about 10 cm to about 70 cm. As described above, the maximum water content should be determined based on the maximum viscosity of the dispersed phase. In some embodiments, the biopolymer is present in the dispersed phase in an amount from about 1 wt % to about 12 wt %, the solvent comprises at least about 0.5 wt % water, the temperature of the dispersed phase is from about 30° C. to about 80° C., and the extruded dispersed phase is dropped from a height of about 10 cm to about 70 cm. In some embodiments, the biopolymer is present in the dispersed phase in an amount from about 1.5 wt % to about 12 wt %, the solvent comprises at least about 0.5 wt % water, the temperature of the dispersed phase is from about 30° C. to about 80° C., and the extruded dispersed phase is dropped from a height of about 10 cm to about 70 cm. In some embodiments, the biopolymer is present in the dispersed phase in an amount from about 2 wt % to about 12 wt %, the solvent comprises at least about 0.5 wt % water, the temperature of the dispersed phase is from about 30° C. to about 80° C., and the extruded dispersed phase is dropped from a height of about 10 cm to about 70 cm. In some embodiments, the biopolymer is present in the dispersed phase in an amount from about 2.5 wt % to about 12 wt %, the solvent comprises at least about 0.5 wt % water, the temperature of the dispersed phase is from about 30° C. to about 80° C., and the extruded dispersed phase is dropped from a height of about 10 cm to about 70 cm. In some embodiments, the biopolymer is present in the dispersed phase in an amount from about 3 wt % to about 12 wt %, the solvent comprises at least about 0.5 wt % water, the temperature of the dispersed phase is from about 30° C. to about 80° C., and the extruded dispersed phase is dropped from a height of about 10 cm to about 70 cm. Each of these biopolymer concentration and dispersed phase temperature ranges can be combined with the above water content ranges, e.g. from about 0.5 wt % to about 12 wt %, and/or the above dropping height ranges, e.g. about 10 cm to about 60 cm or about 20 cm to about 50 cm. Similarly each of these biopolymer concentration and water content ranges can be combined with the above dispersed phase temperature ranges, e.g. from about 30° C. to about 70° C. and/or the above dropping height ranges, e.g. about 10 cm to about 60 cm or about 20 cm to about 50 cm.

In some embodiments, the biopolymer is present in the dispersed phase in an amount of from about 2 wt % to about 12 wt %, the solvent comprises from about 2 wt % to about 12 wt % of water, the temperature of the dispersed phase is from about 20° C. to about 80° C., and the extruded dispersed phase is dropped from a height of about 10 cm to about 70 cm above the surface of the anti-solvent. In some embodiments, the biopolymer is present in the dispersed phase in an amount of from about 2 wt % to about 12 wt %, the solvent comprises from about 2 wt % to about 12 wt % of water, the temperature of the dispersed phase is from about 20° C. to about 80° C., and the extruded dispersed phase is dropped from a height of about 10 cm to about 60 cm above the surface of the anti-solvent.

In some embodiments, the biopolymer is present in the dispersed phase in an amount from about 2 wt % to about 10 wt %, the solvent comprises at least about 1 wt % water, the temperature of the dispersed phase is from about 30° C. to about 80° C., and the extruded dispersed phase is dropped from a height of about 10 cm to about 70 cm. As described above, the maximum water content should be determined based on the maximum viscosity of the dispersed phase.

In some embodiments, the biopolymer is present in the dispersed phase in an amount from about 3 wt % to about 10 wt %, the solvent comprises at least about 1 wt % water, the temperature of the dispersed phase is from about 30° C. to about 80° C., and the extruded dispersed phase is dropped from a height of about 10 cm to about 70 cm. In some embodiments, the biopolymer is present in the dispersed phase in an amount from about 4 wt % to about 10 wt %, the solvent comprises at least about 1 wt % water, the temperature of the dispersed phase is from about 30° C. to about 80° C., and the extruded dispersed phase is dropped from a height of about 10 cm to about 70 cm. Each of these biopolymer concentration ranges can be combined with the above water content ranges, e.g. from about 1 wt % to about 12 wt % and/or the above dropping height ranges, e.g. about 10 cm to about 60 cm or about 20 cm to about 50 cm. Similarly each of these biopolymer concentration and water content ranges can be combined with the above dispersed phase temperature ranges, e.g. from about 30° C. to about 70° C. and/or the above dropping height ranges, e.g. about 10 cm to about 60 cm or about 20 cm to about 50 cm.

In some embodiments, the biopolymer is present in the dispersed phase in an amount of from about 2 wt % to about 12 wt %, the solvent comprises from about 2 wt % to about 12 wt % of water, the temperature of the dispersed phase is from about 20° C. to about 100° C., and the extruded dispersed phase is dropped from a height of about 10 cm to about 70 cm above the surface of the anti-solvent. In some embodiments, the biopolymer is present in the dispersed phase in an amount of from about 2 wt % to about 12 wt %, the solvent comprises from about 2 wt % to about 12 wt % of water, the temperature of the dispersed phase is from about 20° C. to about 80° C., and the extruded dispersed phase is dropped from a height of about 10 cm to about 60 cm above the surface of the anti-solvent.

In some embodiments, the biopolymer is present in the dispersed phase in an amount of from about 2 wt % to about 12 wt %, the solvent comprises from about 2 wt % to about 12 wt % of water, the temperature of the dispersed phase is from about 30° C. to about 80° C., and the extruded dispersed phase is dropped from a height of about 10 cm to about 70 cm above the surface of the anti-solvent. In some embodiments, the biopolymer is present in the dispersed phase in an amount of from about 2 wt % to about 12 wt %, the solvent comprises from about 2 wt % to about 12 wt % of water, the temperature of the dispersed phase is from about 30° C. to about 80° C., and the extruded dispersed phase is dropped from a height of about 20 cm to about 60 cm above the surface of the anti-solvent.

In some embodiments, the biopolymer is present in the dispersed phase in an amount of from about 4 wt % to about 10 wt %, the solvent comprises from about 2 wt % to about 12 wt % of water, the temperature of the dispersed phase is from about 20° C. to about 80° C., and the extruded dispersed phase is dropped from a height of about 10 cm to about 70 cm above the surface of the anti-solvent. In some embodiments, the biopolymer is present in the dispersed phase in an amount of from about 4 wt % to about 10 wt %, the solvent comprises from about 2 wt % to about 12 wt % of water, the temperature of the dispersed phase is from about 20° C. to about 80° C., and the extruded dispersed phase is dropped from a height of about 10 cm to about 60 cm above the surface of the anti-solvent.

In some embodiments, the biopolymer is present in the dispersed phase in an amount of from about 4 wt % to about 10 wt %, the solvent comprises from about 2 wt % to about 12 wt % of water, the temperature of the dispersed phase is from about 30° C. to about 80° C., and the extruded dispersed phase is dropped from a height of about 10 cm to about 70 cm above the surface of the anti-solvent. In some embodiments, the biopolymer is present in the dispersed phase in an amount of from about 4 wt % to about 10 wt %, the solvent comprises from about 2 wt % to about 12 wt % of water, the temperature of the dispersed phase is from about 30° C. to about 80° C., and the extruded dispersed phase is dropped from a height of about 20 cm to about 60 cm above the surface of the anti-solvent.

In some embodiments, the biopolymer is present in the dispersed phase in an amount of from about 4 wt % to about 10 wt %, the solvent comprises from about 2 wt % to about 12 wt % of water, the temperature of the dispersed phase is from about 30° C. to about 70° C., and the extruded dispersed phase is dropped from a height of about 20 cm to about 70 cm above the surface of the anti-solvent. In some embodiments, the biopolymer is present in the dispersed phase in an amount of from about 4 wt % to about 10 wt %, the solvent comprises from about 2 wt % to about 12 wt % of water, the temperature of the dispersed phase is from about 30° C. to about 70° C., and the extruded dispersed phase is dropped from a height of about 30 cm to about 60 cm above the surface of the anti-solvent.

The method of the first aspect may further comprise the step of separating the biopolymer particles from the anti-solvent. The means by which the biopolymer particles may be separated from the anti-solvent are not limited and will be known to a person skilled in the art. For example, in various embodiments, the biopolymer particles may be separated from the anti-solvent by a filtration process. The filtration process is not limited and may involve mechanical or any other type of filtration (e.g. using equipment known in the art such as a hydrocyclone). In various embodiments, a filtration medium (e.g. a filter) may be used to filter the biopolymer particles from the anti-solvent and thereby collect the biopolymer particles.

In various embodiments, the biopolymer particles may be allowed to settle in a vessel and anti-solvent removed or decanted to leave biopolymer particles wetted in residual anti-solvent. Alternatively, the biopolymer particles may be separated by a centrifugal separator or a disk stack separator.

In various embodiments, the biopolymer particles may be washed one or more times, for example with an aqueous solvent including water. Such washing steps may be performed to remove residual ionic liquid that may be present. In various embodiments, the solvent in which the biopolymer particles are immersed may be exchanged for an alternative solvent. In various embodiments, the biopolymer particles are dried. The drying process is not limited and may, for example, involve drying the beads in an oven and/or under reduced pressure.

### Membrane Emulsification

The membrane emulsification step of the second aspect involves passing a dispersed phase through a membrane into a continuous phase so as to form an emulsion. The membrane is not limited; it can be any porous structure suitable for a membrane emulsification process. For example, the membrane may be a plate with holes acting as pores (e.g. micron-sized holes), a perforated metal tube, or sintered porous glass.

By the term “emulsion” is meant the class of two-phase systems of matter where both phases are liquid. Emulsions are a type of colloid, and generally consist of two immiscible liquids. In various embodiments of the present invention the emulsion may be a macro-emulsion; this is an emulsion in which the particles of the dispersed phase have diameters of approximately 1 to 1000 microns. The term “sol” refers to a general class of two-phase systems of matter where the continuous phase is liquid and the dispersed phase is solid.

The membrane emulsification is also not limited and may be any membrane emulsification process known in the art. For example, the membrane emulsification process may be a cross-flow membrane emulsification, a rotational membrane emulsification, a vibrational membrane emulsification, or a combination thereof. As is understood in the art, the terms “cross-flow”, “rotational” and “vibrational” refer to the method used to generate shear on the membrane surface. A continuous phase could, for example, move relative to a stationary membrane to create shear, or the membrane could move relative to stationary phases. Alternatively, the dispersed phase could be injected into a stationary continuous phase. Known process parameters such as membrane type, average pore size and porosity, crossflow velocity, transmembrane pressure and emulsifier may also be used. In various embodiments of the present invention, the membrane emulsification may involve a cross flow system, a stirred-cell tube membrane, a stirred cell-flat membrane, a rotating flat membrane, a vibrating/rotating tube membrane and/or a premixed membrane emulsification.

International Patent Application No. WO 01/45830 describes an example of a rotational membrane emulsification. International Patent Application No. WO 2012/094595 describes an example of a cross-flow membrane emulsification. Pedro S. Silva et al., “Azimuthally Oscillating Membrane Emulsification for Controlled Droplet Production”, AIChE Journal 2015Vol. 00, No. 00, describes a vibrational membrane emulsification: specifically a membrane emulsification system comprising a tubular metal membrane which is periodically azimuthally oscillated in a gently cross flowing continuous phase. WO 2019/092461 describes a cross-flow membrane emulsification. Each of these method descriptions is incorporated herein by reference.

In various embodiments of the present disclosure, the membrane emulsification is a cross-flow membrane emulsification. Preferably an emulsification process in which the continuous phase moves relative to a stationary membrane.

As will be understood by the skilled person in the art, the dispersed phase and continuous phase will depend on the biopolymer being used. Various features of the solvent for the dispersed phase have already been discussed above, and said features individually or in any combination thereof are combinable with the embodiments disclosed herein. The continuous phase will comprise a solvent which is immiscible with the dispersed phase such that an emulsion is formed when the dispersed phase is forced through the porous membrane. The term “solvent” has the meaning as already defined hereinabove.

The two phases—namely the dispersed phase and the continuous phase—must be immiscible with one another. It therefore follows that the solvents for each of the phases must be immiscible with one another. The identification of suitable solvents for the dispersed phase and continuous phase of the second aspect is specifically within the common general knowledge of the skilled person.

The solvent of the continuous phase is not limited other than it must be immiscible with the dispersed phase. The solvent of the continuous phase may be a non-polar solvent. In various embodiments, the solvent of the continuous phase may be selected from hydrocarbon oils and blends thereof. Such hydrocarbon oils may be mineral oils, vegetable oils, or synthetic oils. The solvent of the continuous phase may further comprise water and/or one or more ionic liquids that may be present in residual amounts. Such residues of water and/or ionic liquid may arise as a result of solvent recycling processes.

Preferably the solvent used for the continuous phase is environmentally friendly. More preferably the solvent used for both the dispersed phase and continuous phase is environmentally friendly. The term “environmentally friendly” has the meaning as already defined hereinabove.

The continuous phase may further include optional components. These optional components include, but are not limited to, co-solvents, surfactants, pigments, and dyes. The level of any of the optional components is not significant in the present disclosure. In various embodiments, the continuous phase includes a co-solvent.

The co-solvent is not limited and may be any solvent known in the art. In various embodiments, the co-solvent may be selected from hydrocarbon oils and blends thereof. Such hydrocarbon oils may be mineral oils, vegetable oils, or synthetic oils. The co-solvent may further be a co-solvent mixture.

The surfactant is as defined above.

In various embodiments of the second aspect, the emulsion is cooled to a temperature T₁, T₁ being greater than the pour point of the continuous phase (T_{cont}), and equal to or less than a transition temperature selected from the group consisting of the freezing point, glass transition temperature and pour point, of the dispersed phase (T_{disp}): wherein T_{disp}>T_{cont}. The absolute value of T₁ is not, however, critical to the present disclosure; rather it is the relationship of T₁ to the respective temperatures of the dispersed phase and continuous phase that is important.

The term “pour point” refers to the temperature below which a substance (e.g. liquid) loses its flow characteristics. It is typically defined as the minimum temperature at which the liquid (e.g. oil) has the ability to pour down from a beaker. The pour point can be measured with standard methods known in the art. ASTM D7346, Standard Test Method for No Flow Point and Pour Point of Petroleum Products and Liquid Fuels may, for example be used. For commercially available materials, the pour point is often provided by the supplier or manufacturer.

The term “freezing point” refers to the temperature at which a substance changes state from liquid to solid at standard atmospheric pressure (1 atmosphere). The freezing point can be measured with standard methods known in the art. ASTM E794, Standard Test Method for Melting and Crystallization Temperatures by Thermal Analysis may, for example, be used. For commercially available materials, the freezing point may be provided by the supplier or manufacturer.

The term “glass transition point” or “glass transition temperature” refers to the temperature at which a polymer structure transitions from a hard or glassy material to a soft, rubbery material. This temperature can be measured by differential scanning calorimetry according to the standard test method: ASTM E1356, Standard Test Method for Assignment of the Glass Transition Temperature by Differential Scanning Calorimetry. For commercially available materials, the glass transition temperature may be provided by the supplier or manufacturer.

Since deformation and aggregation are believed to take place when dispersed phase droplets are in a liquid state, the cooling of the emulsion to or below the pour point of the dispersed phase is believed to temporarily change—at least partially-the emulsion's “colloid class” from an emulsion—i.e. liquid-in-liquid—to a sol—solid-in-liquid—and thereby result in the dispersed phase being easier to work with in downstream processes.

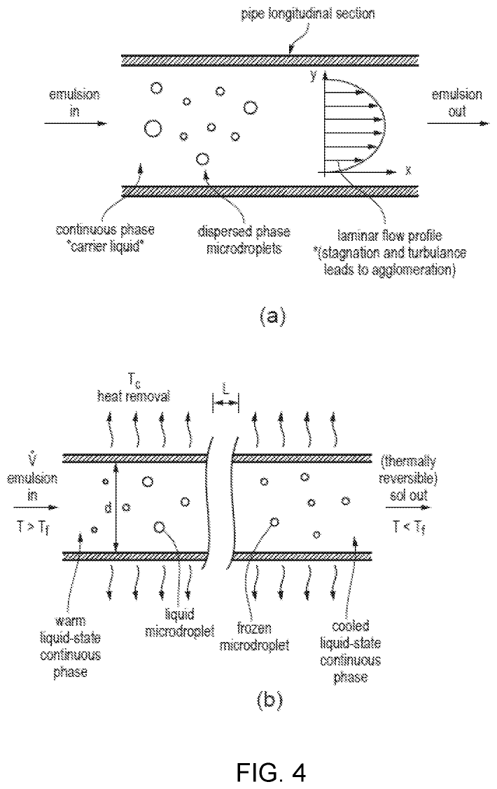

In addition, the dispersed phase having a transition temperature—the transition temperature being selected from the group consisting of freezing point, glass transition temperature and pour point—which is higher than the continuous phase pour point, means that the continuous phase surrounding the solidified dispersed phase is still able to function as a transport medium. A diagrammatic representation of an emulsion undergoing cooling and temporary conversion to a sol within a cooling coil heat exchanger is shown in FIG. 4(b).

FIG. 4(a) is a representation of a process without cooling of the emulsion; the continuous phase forms an emulsion with the dispersed phase droplets (microdroplets in this example), and the stagnation and turbulence in flow causes undesirable coalescence and a reduced yield. FIG. 4(b) is then an example where the emulsion is cooled within a coil heat exchanger to a temperature below the dispersed phase transition temperature but higher than the continuous phase pour point so that the continuous phase remains mobile and is able to transport the transitioned droplets. The exemplary embodiment of FIG. 4(b) avoids the coalescence, deformation, aggregation of particles and consequential reduction of yield encountered with processes as depicted in FIG. 4(a).

The method of cooling is not also limited. The emulsion may be cooled by any means known in the art for removing heat (energy) from a system. The emulsion may further be cooled at any point prior to phase inversion. In various embodiments, this means the emulsion is cooled simultaneously with or separately from the membrane emulsification process. The emulsion may, for example, be cooled as it is formed (e.g. by a cooling means located at the outlet of the membrane). Alternatively, the emulsion may be cooled in a step following membrane emulsification, e.g. in a cooling apparatus separate from the membrane emulsification apparatus. Advantageously, the cooling should take place as soon as possible after the emulsification takes place in order to reduce the possibility of liquid state dispersed phase droplets coalescing and/or aggregating.

In various embodiments, the emulsion may be cooled by a cooling medium (e.g. water, ice etc.) at least partially surrounding the vessel where the emulsion is formed. In a preferred embodiment, the vessel (e.g. pipe) where the emulsion is formed may have a cooling jacket containing a cooling medium. The cooling medium is not limited, and includes any medium having a lower temperature than the emulsion.

In various embodiments the emulsion may be cooled by a cooling apparatus connected to the membrane emulsification unit. The cooling apparatus may be a heat exchanger, such as an immersion heat exchanger. In an exemplary embodiment, a coil heat exchanger is immersed in a cooling medium (e.g. a cold water bath) but the disclosure is not limited in this respect. Any type of heat exchanger could, for instance, be used such as a tube-and-shell heat exchanger, a plate-and-frame heat exchanger, or a jacketed tube. Additionally, an immersion heat exchanger could be used with another cooling medium such as anti-freeze, dry ice or the like, in order to cool the emulsion to T₁.

The temperature of the anti-solvent during phase inversion is discussed above.

In various embodiments of the present disclosure, phase inversion is carried out under shear; the skilled person will be aware of suitable shear conditions for phase inversion. Shear may, for example, be achieved through the use of a stirred vessel (e.g. a mechanically stirred vessel) or a settling vessel (e.g. a gravity settling vessel). The term “shear” is used herein to refer to an external force acting on an object or surface parallel to the slope or plane in which it lies, the stress tending to produce strain.

Shear is advantageous because it improves the rate at which the continuous phase is removed from the dispersed phase droplets, and hence the speed of phase inversion as a whole. The phase inversion process is diffusion rate-limited (Fickian diffusion) and shear reduces the thickness of the continuous phase layer surrounding a dispersed phase droplet, reducing the distance travelled by a molecule of anti-solvent to the surface of the dispersed phase droplet and thereby speeds up the phase inversion process. The use of shear is not, however, typically used with current phase inversion processes because of the negative impact it has on particle shape and size. Currently a gentle phase inversion step is used where the emulsion is allowed to settle through stagnant anti-solvent (at room temperature). Surprisingly, frozen state dispersed phase droplets are more tolerant to other methods of separation from the continuous phase and this improved tolerance increases the efficiency of such separation.

In various embodiments of the present disclosure, phase inversion comprises a filtration process. The filtration process is not limited and may involve mechanical or any other type of filtration (e.g. using equipment known in the art such as a hydrocyclone). A filtration process may also be encompassed by the phase inversion being carried out under shear as described above. In various embodiments, a filtration medium (e.g. filter) may be used to filter the emulsion through the anti-solvent and thereby collect the biopolymer particles. In such embodiments, the emulsion may gravity settle (shear) through the anti-solvent and into the filter, whilst the continuous phase passes through the filter (the filtrate). The frozen droplets may then be collected in the filter as the filter cake.

If not collected as part of phase inversion (e.g. via filtration or otherwise), the biopolymer particles may be separated from the anti-solvent/continuous phase mixture or the anti-solvent/continuous phase mixture may be removed from the particles. The method of removal is not limited. In various embodiments, however, the method of removal depends on whether the method is being operated in batch or continuous mode.

When the method of the second aspect is being operated in batch mode, the phase inversion step may first be performed in a closed vessel and the resulting mixture then transferred into a decanter vessel and allowed to reach a settled stage. Once settled, layers may be removed sequentially from the bottom of the vessel. Typically the order of the layers can be (1) continuous phase, (2) an interfacial layer comprising wetted biopolymer particles and (3) the remaining anti-solvent. The disclosure is not, however, limited in this respect and the skilled person will appreciate that the order of the layers will depend on their respective densities.

In various embodiments of the second aspect, the method is continuous and to operate in continuous mode, the phase inversion step may be performed under continuous input of emulsion and anti-solvent and continuous output of the multi-phase mixture to a decanter. Within the decanter, a steady-state partition of the mixture may exist and there can be a continuous and preferably simultaneous removal from each of the phases. For example, there may be continuous and preferably simultaneous removal from: (1) the continuous phase, (2) anti-solvent and (3) wetted biopolymer particles. The order of these layers will of course vary and the invention is not limited to any particular order.

Alternatively, the multi-phase (e.g. three phase) mixture may be separated using techniques known in the art, such as a disc stack separator (e.g. a centrifugal separator such as the one manufactured by Andritz).

To provide continuous cooling alongside a continuous phase inversion, the cooling medium (e.g. a medium surrounding the vessel containing the emulsion or used with a heat exchanger connected to the membrane emulsification unit) may need to be recycled or recirculated with a suitable device. A device such as a recirculating chiller (ThermoFlex available from ThermoFisher Scientific) may, for example, be used to keep the cooling medium at the desired temperature.

Another advantage of the method according to the second aspect is the flexibility in the sequence of events. This flexibility arises because the droplets of dispersed phase can be frozen within the emulsion. In various embodiments of the disclosure, phase inversion is therefore followed by or involves removal of the biopolymer particles as described above. Phase inversion may be followed by decanting and then biopolymer particle removal from the mixture and/or phase inversion may involve mechanical filtration of the wetted particles from the anti-solvent/continuous phase/particle mixture.

Alternatively, the biopolymer particles may be removed from the continuous phase before phase inversion. In such embodiments, wetted frozen droplets may be removed from the sol (e.g. using filtration) and then phase inversion carried out to precipitate the biopolymer and form beads/particles thereof.

Having generally described this disclosure, a further understanding can be obtained by reference to certain specific examples illustrated below which are provided for purposes of illustration only and are not intended to be all inclusive or limiting unless otherwise specified.

### EXAMPLES

### Materials and methods

### Preparation of cellulose solutions

Microcrystalline cellulose (MCC, from Sigma-Aldrich®) and EmimOAc were dried in a vacuum oven at 80° C. for 1 h to remove traces of water. Cellulose solutions were prepared at concentrations of 4, 6 or 8 wt % MCC in the EmimOAc, both with and without 8 wt % deionized water content. The water was first added to the EmimOAc under stirring, followed by the MCC. The mixture was shaken by hand for a minute, then transferred to rollers for 24 h. The samples were placed in a 70° C. oven for 24 h, stirred with a spatula, left in the oven for a further 24 h, and then finally transferred to the rollers once again for 24 h.

A ‘reference’ cellulose solution was prepared as per the formulation of Coombs Obrien et al¹ (8 wt % MCC in 70:30 mixture of DMSO:EmimOAc). This was also placed in the oven for the same amount of time as the other samples to ensure that all had equal heat exposure.

### Example 1: Characterisation of Cellulose Solutions

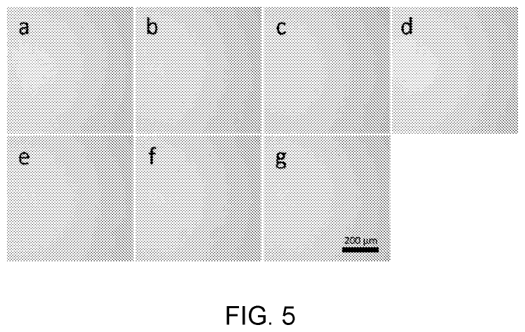

Photographs of the cellulose solutions prepared as detailed above were taken with an iPhone camera, and optical micrographs were captured using a SP400 microscope and digital camera (Olympus). The optical micrographs are presented in FIG. 5.

The photographs showed the appearance of the cellulose solutions in EmimOAc compared to each other and the reference standard, which contains DMSO as a co-solvent. All were transparent, indicating full dissolution of cellulose, which was further confirmed by the lack of particles observed in light microscopy (FIG. 5). These solutions were therefore deemed suitable for further characterisation and preparation of beads.

Further characterisation was conducted by viscosity measurement. Viscosity measurement was conducted using a Discovery HR-3 hybrid rheometer (TA Instruments) fitted with a 40 mm stainless steel parallel plate. The gap was set to 500 μm and the sample was sealed with mineral oil to prevent moisture migration. A logarithmic shear rate sweep was performed from 0.1-100 s⁻¹ (10 points per decade) with a 10 s temperature soak prior to measurement, and the viscosity was recorded from the Newtonian region at 1 s⁻¹. This is the method described hereinabove.

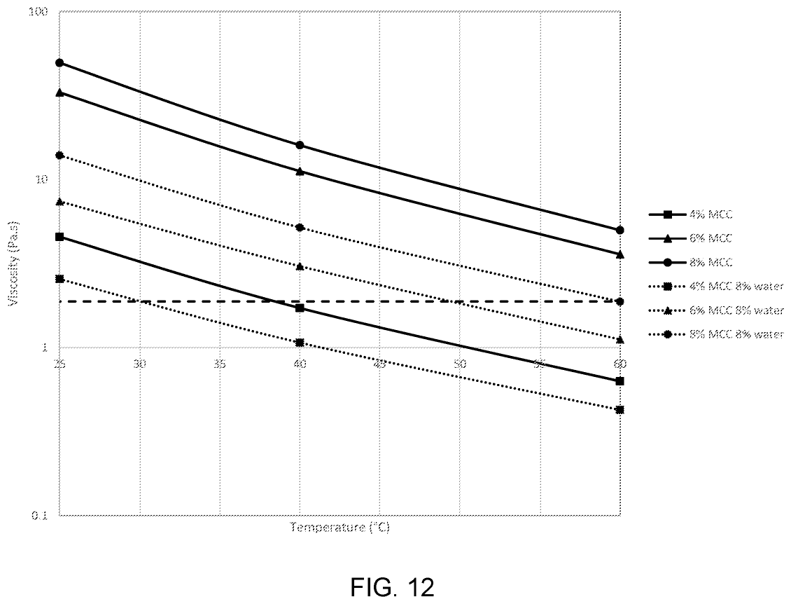

FIG. 12 shows the viscosity of each of the test samples at 1 s⁻¹ and the noted temperature. All samples show the expected reduction in viscosity with increasing temperature and decreasing cellulose concentration. The inclusion of 8 wt % water was found to significantly decrease the viscosity at all cellulose concentrations. As noted hereinabove, MCC concentrations lower than 8 wt % may be able to withstand a higher water content without precipitation which could result in an even lower viscosity. Hence the present disclosure is not limited to a water content of 8 wt %.

The value at which the solution curves intercept the horizontal dashed line can be used as an estimate of the temperature required to achieve the same viscosity as the DMSO-containing reference standard at room temperature and hence the temperature for the extrusion. This temperature is shown in the table below.

Temperature (° C.)

| MCC (wt %) | 0 wt % water | 8 wt % water |
|---|---|---|
| 4 | 40 | 30 |
| 6 | 70 | 50 |
| 8 | 75 | 60 |

It can be seen how the presence of water in the dispersed phase lowers the viscosity of the cellulose solution without precipitation and means that a lower temperature can be used to obtain a viscosity similar to that of the DMSO-containing reference standard at room temperature. This is a further advantage of the present disclosure which contributes to the overall environmental benefit being provided.

### Example 2: Preparation of Cellulose Beads

Each of the cellulose solutions prepared as detailed above were divided into three samples. The first sample was used at room or ambient temperature (RT in FIG. 6), the second sample was heated to 40° C. and the third sample was heated to 60° C. Once at the requisite temperature, the samples were respectively loaded into a 10 ml plastic syringe and a 23 gauge blunt-tipped stainless steel needle was fitted. The solution was immediately extruded from the needle dropwise at 0.1 mL/min via syringe pump into water (anti-solvent). The ambient room temperature during dropping was around 15° C. An appropriate dropping height for optimal sphericity was selected by eye for each sample, up to a maximum of 60 cm. Only a small number of beads were produced to avoid the effects of pressure build-up. The beads were washed with water 3 times over 3 days and dried at 80° C. overnight.

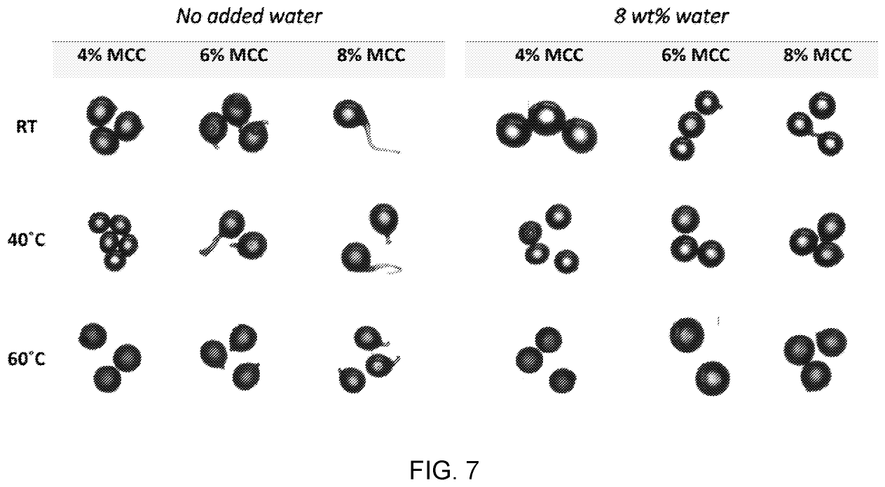

Photographs of beads in their wet state after coagulation in water were taken with an iPhone camera fitted with a commercially available macro lens clip. These are shown in FIG. 6. Optical micrographs of dried beads were taken with an EVOS M5000 microscope. These are shown in FIG. 7.

Beads were produced by a needle dropping procedure at room temperature, 40° C., and 60° C. in Example 2 in order to assess which solutions, if any, could be used to make spherical beads. In unfavourable cases, the resulting beads may have tails, or the solution may be extruded in an unbreaking stream resulting in a stringy mass. FIGS. 6 and 7 show, that the presence of water in the dispersed phase improves the sphericity of the beads compared to a dispersed phase without water. This improvement is especially seen at higher concentrations of cellulose.

### Example 3: Preparation of Cellulose Beads Using a Heated Syringe and Needle

The 8 wt % MCC and 8 wt % water in EmimOAc solution and the 6 wt % MCC and 8 wt % water in EmimOAc solution described above were subject to further tests in Example 3. These tests were intended to supplement the observations made in Example 2.

The solutions were respectively loaded into a 50 ml glass syringe and a 23 gauge blunt-tipped stainless steel needle was fitted. Heating mats were fixed around the syringe and needle, and a thermocouple was attached to the metal needle thread. The heater was set to 70° C. and allowed to cool, and beads were collected at 10° C. intervals, using the displayed needle temperature. The solution was extruded from the needle dropwise at 0.05 mL/min via syringe pump into water (anti-solvent), at dropping heights of 13, 26 or 39 cm. The ambient room temperature during dropping was around 20° C. The beads were washed with water 3 times over 3 days and dried at 80° C. overnight.

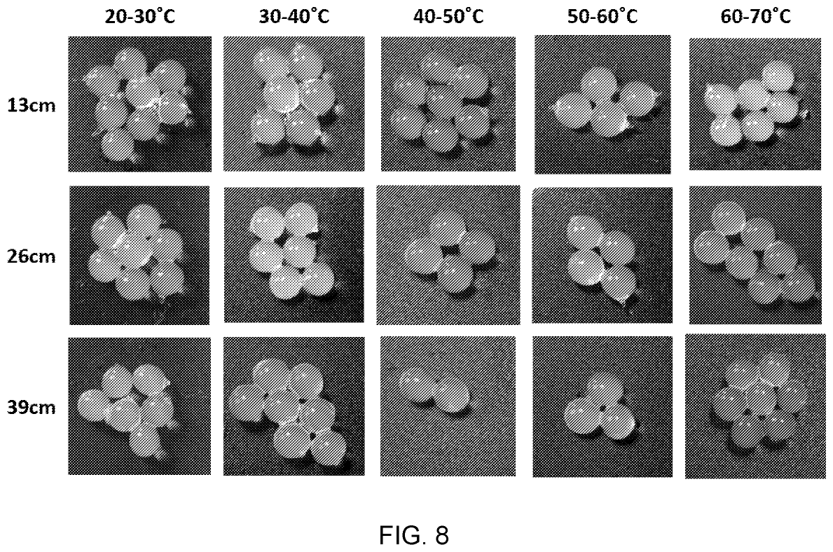

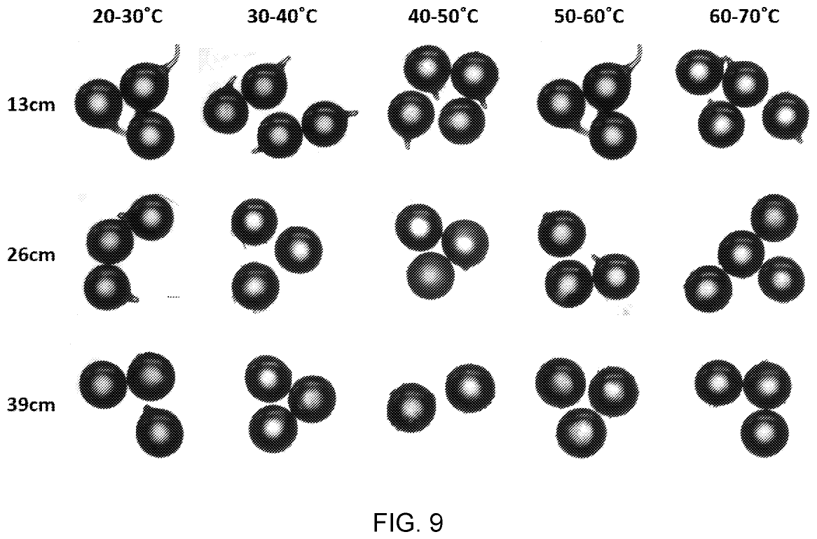

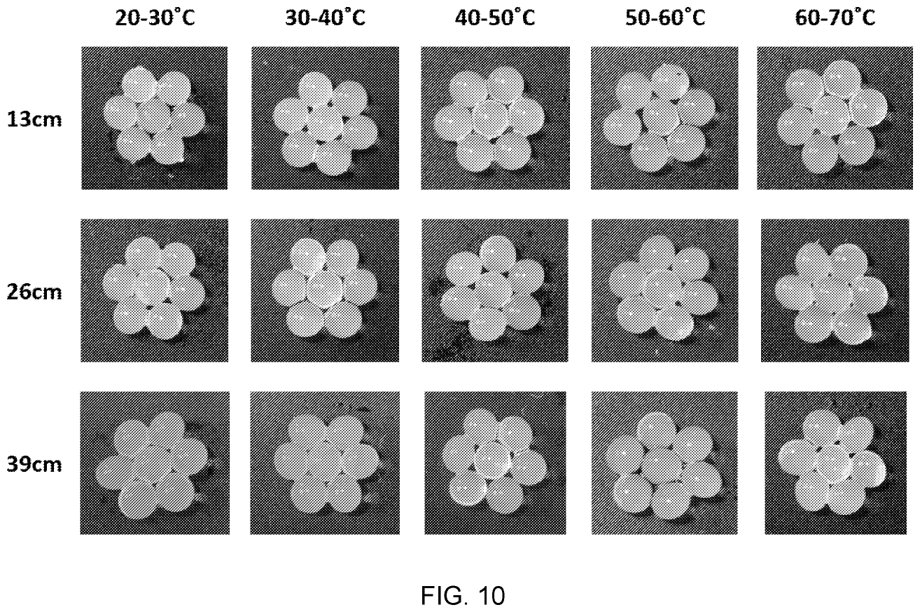

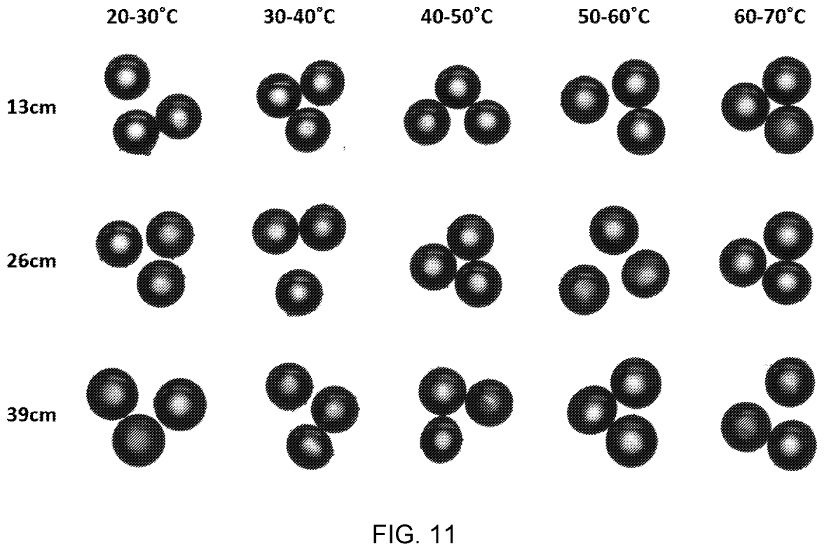

Photographs of beads in their wet state after coagulation in water were taken with an iPhone camera fitted with a commercially available macro lens clip. These are shown in FIGS. 8 and 10. Optical micrographs of dried beads were taken with an EVOS M5000 microscope. These are shown in FIGS. 9 and 11.

The results (FIGS. 8-11) show that spherical beads were obtained using each of the 6 wt % and 8 wt % MCC solutions containing 8 wt % water in EmimOAc. These results also show how a higher temperature and dropping height favour sphericity, particularly in the case of the 8 wt % solution.

### Conclusions

The Examples 1 to 3 show that although a solution of 8 wt % MCC in pure EmimOAc is indeed far more viscous than 8 wt % MCC in 70:30 DMSO:Emimoac, the inclusion of 8 wt % water can significantly decrease the viscosity such that the solution can be used in a bead dropping process to prepare spherical cellulose beads. Water inclusion in the cellulose solution increased the likelihood of bead sphericity by viscosity reduction which minimised tailing. This is an important finding since residual water in EmimOAc from the solvent recovery process is inevitable where water is used as the antisolvent. With the 6 wt % and 8 wt % solutions containing 8 wt % water, controlled experiments allowed the determination of a suitable range of parameters (temperature and dropping height) for optimal bead sphericity.

### Example 4: Membrane Emulsification

A dispersed phase comprising 8 wt % microcrystalline cellulose and 8 wt % water in 1-ethyl-3-methylimidazolium acetate was prepared according to routine methods known in the art. This dispersed phase had a transition temperature (e.g. freezing point) of approximately −5° C. An aqueous continuous phase was also prepared according to routine methods known in the art. The continuous phase had a pour point of −15° C.

The dispersed phase and continuous phase were fed into a membrane emulsification unit and an emulsion thereby formed. The emulsion was then cooled to a temperature between 0 and 11° C. before being transferred into a phase inversion unit with an aqueous anti-solvent to form cellulose particles.

Cooling of the emulsion was carried out with an immersed coil heat exchanger. The immersed coil heat exchanger was chosen to maintain a laminar flow and minimise flow disturbances as the emulsion cooled. The coil heat exchanger contained a length (L) of coiled tubing with diameter D and pitch P, in a cold water bath at 0° C. and was sufficient to cool a 0.5 L/min emulsion to below 11° C. The temperature of the emulsion was monitored with a thermometer at the exit of the coil heat exchanger. Spherical biopolymer particles were thereby obtained.

1. A method for preparing biopolymer particles, said method comprising extruding a dispersed phase into an anti-solvent to form particles of the biopolymer,
wherein the dispersed phase comprises the biopolymer in a solvent, and
wherein each of the solvent and anti-solvent comprises water.

2. A method for preparing biopolymer particles, said method comprising:
a. a membrane emulsification of a dispersed phase into a continuous phase wherein the dispersed phase comprises the biopolymer in a solvent, and wherein passing the dispersed phase through the membrane forms an emulsion of the biopolymer in the continuous phase; and
b. a phase inversion with an anti-solvent to form particles of the biopolymer;
wherein each of the solvent and anti-solvent comprises water.

3. The method of claim 1 wherein extruding the dispersed phase into an anti-solvent to form particles of the biopolymer comprises extruding the dispersed phase through a fluid medium by capillary extrusion.

4. The method of claim 1 wherein extruding the dispersed phase into an anti-solvent to form particles of the biopolymer comprises extruding the dispersed phase through a fluid medium into a mould and then contacting the extruded dispersed phase with the anti-solvent.

5. (canceled)

6. The method of claim 2 wherein prior to (b), the emulsion is cooled to a temperature, T₁, T₁ being greater than the pour point of the continuous phase (T_{cont}), and equal to or less than a transition temperature of the dispersed phase (T_{disp}): T_{cont}<T₁≤T_{disp}; wherein the transition temperature is selected from the group consisting of the freezing point, the glass transition temperature, and the pour point; and
wherein T_{disp}>T_{cont}.

7. The method of claim 6 wherein the anti-solvent is cooled to a temperature, T₂, for the phase inversion (b), T₂ being less than T_{disp}.

8. (canceled)

9. The method of claim 1 wherein the biopolymer is a polysaccharide.

10. The method of claim 9 wherein the biopolymer is cellulose and is selected from the group consisting of virgin, recycled, pulp, and microcrystalline cellulose, and combinations thereof.

11. The method of claims 1 wherein the biopolymer is present in the dispersed phase in an amount from about 2 wt % to about 12 wt %, based on the total weight of the dispersed phase.

12. The method of claims 1 wherein the dispersed phase is prepared by the addition of the biopolymer to the solvent, and wherein the solvent comprises water prior to the addition of the biopolymer or wherein the solvent comprises water only after the addition of the biopolymer.

13. The method of claim 1 wherein the solvent of the dispersed phase comprises from about 2 wt % to about 12 wt % of water.

14. The method of claim 1 wherein the solvent of the dispersed phase further comprises an ionic liquid.

15. The method of claim 1 wherein the anti-solvent is substantially free of organic solvents.

16. The method of claim 1 wherein the anti-solvent further comprises an ionic liquid.

17. (canceled)

18. The method of claim 1 wherein the anti-solvent consists of water.

19. (canceled)

20. The method of claim 1 wherein the temperature of the dispersed phase during extrusion or membrane emulsification is from about 5° C. to less than about 100° C.

21. The method of claim 1 wherein the temperature of the antisolvent is from about 5° C. to about 80° C.

22. Biopolymer particles prepared by the method according to claim 1.

23. The biopolymer particles of claim 22 wherein the diameter of said particles is from about 1 μm to about 500 μm.

24. (canceled)

25. The biopolymer particles of claim 22 wherein the diameter of said particles is from about 1 mm to about 10 mm.
